(19) United States
(12) Patent Application Publication
(10) Pub. No.: US 2001/0012574 A1
(43) Pub. Date: Aug. 9, 2001

(54) Magnetic recording medium

(75) Inventors: Yoshiteru Matsubayashi, Mito-shi (JP); Hiroto Nagamine, Mito-shi (JP)

Correspondence Address: Pollock, Vande Sande & Amernick, R.L.L.P., P.O. Box 19088, Washington, DC, 20036-0088, US

(73) Assignee: Victor Company of Japan, Ltd., Kanagawa-ken (JP)

(21) Appl. No.: 09/756,797

(22) Filed: Jan. 10, 2001

(30) Foreign Application Priority Data
Jan. 21, 2000 (JP) 2000-012732/2000
May 10, 2000 (JP) 2000-136848/2000
May 11, 2000 (JP) 2000-138166/2000
Jun. 2, 2000 (JP) 2000-165577/2000

(51) Int. Cl. G11B 5/706

(52) U.S. Cl. 428/694 BA

(57) ABSTRACT

A magnetic recording medium of a coated type being formed by coating magnetic paint, which is mixed with and dispersed by a magnetic powder and a resin and an additive, on a substrate, the magnetic powder comprises a magnetite (Fe₃O₄) powder of which a surface is stuck with powdered carbon black, wherein a sticking amount of the powdered carbon black is within a range of 1 to 20 weight % per the magnetite powder.

### BACKGROUND OF THE INVENTION

1. Field of the Invention

The present invention relates to a magnetic recording medium, which is manufactured by coating magnetic paint produced by mixing and dispersing additives such as a magnetic powder, a resin, a lubricant, and an abrasive on a substrate, particularly, relates to a magnetic recording medium, which is improved in dispersiveness of the magnetic paint during mixing and dispersing process, a light shielding characteristic of a magnetic layer, an electrical resistance on a surface of the magnetic layer, an electromagnetic conversion characteristic, a stain on a head, running ability in an apparatus (hardware), and jitter of a reproduced signal and is excellent in durability and reliability by increasing mechanical strength of the magnetic layer, and further the magnetic recording medium is improved in not only a carrier to noise ratio (C/N) by increasing dispersion efficiency so as to improve surface roughness but also microscopic dropout decreased in compliance with digital recording.

2. Description of the Related Art

In a magnetic recording medium of a coated type comprising a magnetic layer for recording, the magnetic layer contains a resin, so that the magnetic recording medium exhibits excellent durability when it is used as a recording medium. A manufacturing cost of the magnetic recording medium is lower than that of a recording medium comprising metal thin film as a recording layer, so that the magnetic recording medium is excellent in cost-performance and has come into wide use. It is commonly used for such as a ticket for traffic facilities, a credit card, an audio tape, and a video tape. A substrate of a credit card is plastic plate and that of a video tape is plastic film such as polyester film. These substrates are in high electrical insulation and remarkably generate static electricity particularly in a dry surrounding. Generated static electricity absorbs dust and, in some cases, discharges if an electrification amount of static electricity increases extremely, and noise may be generated by the discharge. In a case that dust is stuck on a surface of a magnetic layer on which a magnetic head contacts and slide, the dust may cause dropout of a signal and a scratch on the magnetic head and the surface of the magnetic layer. These dropout of a signal and scratches are particularly caused by an extremely high electrical resistance of the magnetic layer. Accordingly, it is required that an electrical resistance of magnetic layer must be decreased so as to eliminate static electricity.

Further, with respect to a recent magnetic recording medium such as a video tape, high density recording and high reliability when recording and reproducing is strictly required. A magnetic tape utilized for the S-VHS and D-VHS formats, for example, is required of improving a reproduction output and a carrier to noise ratio (C/N) in a higher frequency range of 8 to 10 MHz in comparison with a regular VHS tape. Furthermore, by recording in a short wavelength, a spacing loss between a magnetic head and a magnetic tape seriously affects such that variation per hour caused by a magnetic head slightly stained and small expansion of a magnetic tape, inferior durability due to a lack of coated film strength, and a lowered output may happen and finally a reproduced picture is influenced by the spacing loss. In order to suppress an increase of dropout caused by dust affixed on a surface of a magnetic tape, powdered carbon black is usually added to a magnetic layer for a purpose of reducing electrical resistance and a purpose of reducing light transmittance of a recording section of a magnetic tape so as to detect a tape end by transmittance difference between a leader tape section and a recording section as a regular VHS video deck does. However, carbon black is hard to disperse in a magnetic layer because of too strong flocculation of carbon black.

To solve the problems mentioned above, binders utilized commonly in a magnetic recording medium are studied. One of them, a polyurethane resin improved on functional polar group is introduced.

The Japanese Patent Publication No. 58-41565/1983 and the Japanese Patent Laid-open Publication No. 1-91315/1989 disclose binders of dispersing metal sulfonate group and tertiary amine in a polyurethane resin respectively. However, current magnetic iron oxide and carbon black is insufficient in dispersion, so that surface roughness is hard to be improved and a coated film is insufficient in strength. Accordingly, further improvement is required.

Furthermore, recording in high density and playing in long period of time is more advanced recently, so that a thinner tape-shaped medium and its higher reliability is strictly required when recording and reproducing. A magnetic tape utilized for the S-VHS and D-VHS formats, for example, is required of improving an output and a carrier to noise ratio (C/N) in a frequency range of 8 to 10 MHz in comparison with a regular VHS tape. Moreover, in a case of a D-VHS tape, a total thickness of the tape is thin such as less than 12 μm, as it is called a 24 hour tape, so that a tape-shaped medium is worried about deteriorating its mechanical strength. In addition thereto, by recording in a short wavelength, a spacing loss between a magnetic head and a magnetic tape seriously affects such that reliability is deteriorated and flatness of envelope is decreased by a slightly stained magnetic head and rough contact between the magnetic head and the magnetic tape.

In order to improve light shielding ability and an electrical resistance of magnetic layer, powdered carbon black is added to a magnetic layer. In other words, carbon black is added to a magnetic paint and mixed so as to disperse when the magnetic paint is produced. When carbon black is added to a magnetic paint, dispersiveness of not only carbon black itself but also magnetic powder is deteriorated because of too strong flocculation of carbon black. Accordingly, an electromagnetic conversion characteristic of a magnetic recording medium finally produced is deteriorated. Essentially, in a process of dispersing magnetic powder, influence of lowered dispersiveness of carbon black and magnetic powder is remarkably large because of flocculation by magnetization of magnetic powder itself. The Japanese Patent Laid-open Publication No. 3-1505/1991 discloses a method of forming a carbon film on a surface of magnetic powder other than the method of adding carbon black to a magnetic layer mentioned above. According to the disclosure, a surface of magnetic powder is coated with an organic material such as acrylic ethyl and xylene, and the organic material is carbonized with decomposition by a high temperature treatment in an atmosphere of inert gas, and finally a carbon film is formed on the surface of the magnetic powder.

However, in this method disclosed by the Japanese Patent Laid-open Publication No. 3-1505/1991, further problems occurred such that a magnetic characteristic of magnetic powder was deteriorated by a high temperature treatment in an atmosphere of inert gas and that properties of magnetic paint produced by using the magnetic powder treated by a high temperature were deteriorated and dispersion was hardly progressed. Such problems are supposed to be caused by that an active Fe element slightly existing in magnetic powder combines with the organic material during the process of carbonizing the organic material with decomposition and that the combined material deteriorates the magnetic characteristic of the magnetic powder and the properties of the magnetic paint during the process of dispersing the magnetic paint. Accordingly, a magnetic tape produced by coating the magnetic paint mentioned above can not ensure sufficient characteristics, particularly, an electrical resistance and light shielding ability of a recording layer can not be compatible with an electromagnetic conversion characteristic of the recording layer. In order to compensate these defects, it is proposed that a layer having a low electrical resistance and a light shielding ability is provided as a first layer of a magnetic layer or a back coating layer of the magnetic layer. However, a process of coating the first layer or the back coating layer is required, so that a total coating or painting process is complicated and causes an increase of a manufacturing cost.

### SUMMARY OF THE INVENTION

Accordingly, in consideration of the above-mentioned problems of the prior arts, an object of the present invention is to provide a magnetic recording medium, which can maintain an electrical resistance on a surface of a magnetic layer or a recording layer in low and a light shielding ability in high and can improve an electromagnetic conversion characteristic. Further, the magnetic recording medium can ensure excellent travelling ability of a tape and can decrease jitter of reproduced signal, and a simple coating process reduces a manufacturing cost. Furthermore, the magnetic recording medium is excellent in high film strength and durability, in conjunction with exhibiting a high reproduction output and excellent surface roughness by improved dispersiveness of magnetic powder and it can be applied to high density digital recording such as the D-VHS system. Moreover, stiffness and reliability of the magnetic recording medium can be increased by improving dispersion of magnetic paint during a process of mixing and dispersing a magnetic powder, a binder, and additives and mechanical strength of the magnetic layer greatly.

In order to achieve the above object, the present invention provides, according to an aspect thereof, a magnetic recording medium of a coated type being formed by coating magnetic paint, which is mixed with and dispersed by a magnetic powder and a resin and an additive, on a substrate, the magnetic powder comprising magnetite (Fe₃O₄) powder of which a surface is stuck with powdered carbon black, wherein a sticking amount of the powdered carbon black is within a range of 1 to 20 weight % per the magnetite powder.

According to another aspect of the present invention, a magnetic recording medium of a coated type is provided. The magnetic recording medium is formed by coating magnetic paint, which is mixed with and dispersed by a magnetic powder and a resin and an additive, on a substrate, the magnetic powder comprising magnetite (Fe₃O₄) powder of which a surface is stuck with powdered carbon black, wherein a sticking amount of the powdered carbon black is within a range of 3 to 15 weight % per the magnetite powder, and wherein a BET (Brunauer-Emmett-Teller) specific surface area of the magnetic powder is within a range of 25 to 45 m²/g, and wherein an absorbing amount of myristic acid of the magnetic powder is within a range of 8 to 25 mg/g.

According to a further aspect of the present invention, a magnetic recording medium of a coated type is provided. The magnetic recording medium is formed by coating magnetic paint, which is mixed with and dispersed by a magnetic powder and a binder and an additive, on a substrate, the magnetic powder comprising magnetite (Fe₃O₄) powder of which a surface is stuck with powdered carbon black, wherein a sticking amount of the powdered carbon black is within a range of 1 to 20 weight % per the magnetite powder, the binder comprising a polyurethane resin, which contains metal sulfonate group and tertiary amine.

According to a furthermore aspect of the present invention, a magnetic recording medium of a coated type is provided. The magnetic recording medium is formed by coating magnetic paint, which is mixed with and dispersed by a magnetic powder and a binder and an additive, on a substrate, the magnetic powder comprising magnetite (Fe₃O₄) powder of which a surface is stuck with powdered carbon black, wherein a sticking amount of the powdered carbon black is within a range of 3 to 15 weight % per the magnetite powder and a pH of the powdered carbon black is less than 4, and wherein a BET specific surface area of the magnetic powder is within a range of 25 to 45 m²/g.

Other objects and further features of the present invention will be apparent from the following detailed description when read in conjunction with the tables.

### BRIEF DESCRIPTION OF DRAWINGS

FIG. 1 is a cross sectional view of a classifier, which is utilized for manufacturing magnetic powder used for a magnetic recording medium according to an first and third embodiments of the present invention.

### DETAILED DESCRIPTION OF THE PREFERRED EMBODIMENTS

[First Embodiment]

(Embodiments 1 to 7 and comparative examples 1 to 9)

Prior to a detailed description of a first embodiment of the present invention, an outline of the present invention is explained first. First of all, a major point of the present invention is that a magnetite powder of which a surface is stuck with powdered carbon black is adopted as a magnetic powder utilized for a magnetic layer. Further, a sticking amount of the powdered carbon black is within a range of 1 to 20 weight % per magnetite powder. Furthermore, a coefficient of friction on a surface of the magnetic layer is 0.1 through 0.4.

A magnetite powder in an acicular shape is utilized for a core material of a magnetic powder. A magnetite powder of Fe₃O₄ is superior to Fe₂O₄ in magnetization and is suitable for realizing an excellent magnetic characteristic. In a case that the magnetite powder is utilized for a magnetic recording medium as a core material, a metallic additive such as Co, Ni, Mn, Sn, or Cr is adhered on a surface of the magnetite powder for a purpose of improving a magnetic characteristic and corrosion resistance. Further, in order to prevent a magnetic powder from sintering during a manufacturing process of the magnetic powder, it is commonly performed that another metallic additive such as Al or Si is adhered on the surface of the core material or the magnetite powder. An experiment is performed by using special magnetic powder, which is furthermore stuck with particles of powdered carbon black layering over a metallic additive such as Co, Ni, Mn, Sn, Cr, Al, or Si adhered on the surface of the core material or the magnetite powder. According to the experiment, the particles of powdered carbon black layered over the metallic additive adhered on the surface of the magnetite powder is not affected by such the metallic additive, so that an effect of sticking particles of powdered carbon black on a magnetite powder, which is made most suitable for a magnetic characteristic and corrosion resistance and sintering respectively, is confirmed.

With respect to a particle size of magnetite powder, a magnetic recording medium is utilized for various applications such as a magnetic card, a ticket for traffic facilities, a magnetic tape, and a magnetic disk, so that the particle size can not be limited to a specific one. However, in a case of manufacturing a video tape, which is utilized for high density recording such as the VHS standard mentioned above, a shape of magnetite powder is acicular and a length of major axis being suitable for use is 0.05 to 1.0 μm preferably 0.07 to 0.2 μm. According to the VHS standard, the minimum recording wavelength is 0.5 to 1.0 jam, so that the major axis length of 0.05 to 1.0 μm can improve an output and a carrier to noise ratio (C/N) of a reproduced signal of the recording wavelength. With respect to an aciculate ratio of acicular powder, an aciculate ratio being suitable for use is 3 to 25 preferably 5 to 15 in consideration of destruction of a magnetic powder during mixture and dispersion, a magnetic orientation after coating magnetic paint on a substrate, and a magnetic characteristic of a magnetic recording medium thereafter. Because the aciculate ratio of 3 to 25 is most suitable for a property of orientation when orienting a magnetic powder and minimizing possible breakage of the magnetic powder. With respect to an amount of saturation magnetization and coercive force as magnetic characteristics of a magnetic powder, the larger the amount of saturation magnetization is, the more excellent characteristic a reproduced output exhibits. However, 68 to 81 emu/g of saturation magnetization is practical in consideration of corrosion resistance. 54 to 90 kA/m of coercive force is practical although coercive force is usually adjusted in accordance with a format to be used.

In a case that a coefficient of kinetic friction exceeds 0.4, a head stain of magnetic head is deteriorated. If a surface of magnetic layer is treated so as to decrease the coefficient of kinetic friction as low as less than 0.1, an electromagnetic conversion characteristic of a magnetic layer becomes insufficient. In a case that the coefficient of kinetic friction is lowered by adding lubricant, durability is deteriorated. Accordingly, in order to use a magnetic recording medium produced in a hardware such as a video deck having a tape transportation system, a coefficient of kinetic friction of a surface of a magnetic layer is required to be within a range of 0.1 to 0.4.

A coupling agent is effective in sticking a carbon black particle on a magnetite powder. Because a ratio of carbon black sticking on a magnetic powder increases. A coupling agent used herein is alkoxy silane such as methyl triethoxy silane, dimethyl diethoxy silane, tetraethoxy silane, phenyl triethoxy silane, diphenyl diethoxy silane, dimethyl dimethoxy silane, methyl trimethoxy silane, tetramethoxy silane, phenyl trimethoxy silane, diphenyl dimethoxy silane, isobutyl trimethoxy silane, and decyl trimethoxy silane.

With respect to a diameter of particle of carbon black stuck on a surface of magnetite powder, a particle diameter of carbon black is preferably to be 10 to 40 nm in comparison with that a desirable particle length of a major axis of magnetic powder is 0.07 to 0.2 μm, although a relative dimension of a carbon black particle to a particle of magnetic powder is considered so as to be stuck on a surface of magnetic powder. If a particle diameter of carbon black is less than 10 nm, the particle is too small to handle in a manufacturing process. On the other hand, if the particle diameter of carbon black exceeds 40 nm, a particle size of magnetic powder, which is stuck with the carbon black, is too large to cope with high density recording.

Actual product names of carbon black are as follows: manufactured by Cabot Corporation such as Monarch 430, Monarch 460, Monarch 800, Monarch 880, Monarch 900, Black Pearls 430, Black Pearls 460, Black Pearls 700, Black Pearls 800, Black Pearls 900, Black Pearls 1000, Black Pearls 1100, Black Pearls 1300, Black Pearls 1400, and Black Pearls L, manufactured by Columbia Carbon Japan, Ltd. such as Conductex 975, Raven 820, Raven 850, Raven 890, Raven 1000, Raven 1020, Raven 1035, Raven 1170, Raven 1200, Raven 1255, Raven 2000, Raven 3500, Raven 5250, Raven 5750, and Raven7000, and manufactured by Mitsubishi Chemical Corporation such as MA100, MA100R, MA7, and MA8.

A resin constitutes a magnetic layer in conjunction with a magnetic powder and functions as a binder. A role of the resin is to wrap up pigment without adhesion and to adhere the pigment to a surface of a base film. As for the resin, there provided such resins as thermoplastic resin, thermosetting resin, reactive resin, and their mixture. These resins are, for example, polymer or copolymer such as vinyl chloride, nitrocellulose, vinyl acetate, vinyl alcohol, maleic acid, acrylic acid, acrylate, vinylidene chloride, acrylonitrile, methacrylic acid, methacrylate, styrene, butadiene, ethylene, vinylbutyral, vinyl acetal, and vinyl ether, and resins such as polyurethane resin, phenol resin, epoxy resin, polyurethane curable resin, urea resin, melamine resin, alkyd resin, acrylic family reactive resin, formaldehyde resin, silicon resin, epoxy polyamide resin, and a mixture of polyester resin and isocyanate prepolymer.

The above-mentioned resins can be used alone or as a combination of several resins. A preferable combination of resins is a combination of one of vinyl chloride resin, vinyl chloride vinyl acetate resin, vinyl chloride vinyl alcohol acetate resin, and copolymer of vinyl chloride vinyl acetate maleic anhydride, and both of polyurethane resin and polyisocyanate.

Those resins mentioned above are as follows: manufactured by Nisshin Chemical Industry Co. such as MPR-TA, MPR-TA5, MPR-TAL, MPR-TSN, MPR-TMF, MPR-TS, MPR-TM, and MPR-TAO, manufactured by Denka Co. such as 1000W, DX80, DX81, DX82, DX83, and 100FD, manufactured by Zeon Corporation such as MR100, MR105, MR110, MR113, and 400X110A, manufactured by Nippon Polyurethane Industry Co. such as Nipporun N2301, N2302, N2304, N3118, and BN-600, manufactured by Dainippon Ink And Chemicals Incorporated such as Pandex T-5105, T-R3080, T-5201, Vernox D-400, D-210-80, Chryspon 6109, and 7209, manufactured by Toyobo Co., Ltd. such as Vylon UR8200, UR8300, UR8600, UR5500, UR4300, RV530, and RV280, manufactured by Dainichiseika Color & Chemicals Mfg. Co. such as Daiferamine 4020, 5020, 5100, 5300, 9020, 9022, and 7020, manufactured by Mitsubishi Chemical Corporation such as MX5004, manufactured by Sanyo Chemical Industries Ltd. such as Sanprene SP-150, manufactured by Asahi Chemical Industry Co. such as BT-SL, BTH-1/16, BTH-1/4, BTH-1/2, BTH-1, Saran F310, and F210, manufactured by Nippon Polyurethane Industry Co. such as Colonate L, Colonate HL, Colonate 2030, Colonate 2031, Milionate MR, and Milionate MTL, manufactured by Takeda Chemical Industries, Ltd. such as Takenate D-102, Takenate D-11ON, Takenate D-200, and Takenate D-202, and manufactured by Sumitomo-Bayer such as Desmodur L, Desmodur IL, Desmodur N, and Desmodur HL.

An abrasive contained in a magnetic layer is utilized for scraping off hard articles adhered on a surface of a magnetic head in conjunction with protecting a tape surface from being scraped off. As for abrasives, there provided such abrasives as alumina, silicon carbide, chromium oxide, cerium oxide, α-iron oxide, corundum, silicon nitride, titanium carbide, titanium oxide, silicon dioxide, and boron nitride. A particle size of these abrasives is preferred to be within a range of 0.01 to 4 μm. They can be used as a combination of several abrasives in various materials and particle sizes or one abrasive alone. Actual products of abrasives are as follows: manufactured by Norton Co. such as E-300, E-330, E-400, E-440, E-500, and E-600, manufactured by Sumitomo Chemical Co. such as AKP-20, AKP-30, AKP-50, HIT-20, HIT-30, and HIT-50, manufactured by Nippon Chemical Industrial Co., Ltd. such as G5, G7, and S-1, manufactured by Toda Kogyo Corp. such as TF-100, TF-140, and TF-160. Further, carbon black can be added as far as it does not affect a characteristic.

Additives having effects of lubrication, dispersion, and plasticity contained in a magnetic layer are as follows: molybdenum disulfide, tungsten disulfide, graphite, boron nitride, graphite fluoride, silicon oil, polar group silicon, fatty acid denaturation silicon, silicon containing fluorine, alcohol containing fluorine, ester containing fluorine, polyolefin, polyglycol, alkyl phosphoric ester, alkali metallic salt of alkyl phosphoric ester, alkyl sulfuric ester, alkali metallic salt of alkyl sulfuric ester, polyphenyle ether, alkyl sulfuric ester containing fluorine, alkali metallic salt of alkyl sulfuric ester containing fluorine, monobasic fatty acid containing 10 to 24 carbon atoms, metallic salt of monobasic fatty acid containing 10 to 24 carbon atoms, monohydric and dihydric and trihydric and tetrahydric and pentahydric and hexahydric alcohol containing 12 to 22 carbon atoms, alkoxy alcohol containing 12 to 22 carbon atoms, mono fatty acid ester or di-fatty acid ester or tri-fatty acid ester composed of monobasic fatty acid containing 10 to 24 carbon atoms and either one of monohydric and dihydric and trihydric and tetrahydric and pentahydric and hexahydric alcohol containing 2 to 12 carbon atoms, fatty acid ester of mono-alkyl ether of alkylene oxide polymer, fatty acid amide containing 8 to 22 carbon atoms, and fatty acid amine containing 8 to 22 carbon atoms. Detailed additives are as follows: lauric acid, myristic acid, palmitic acid, stearic acid, behenic acid, butyl stearic acid, oleic acid, linoleic acid, linolenic acid, elaidic acid, octyl stearic acid, amyl stearic acid, iso-octyl stearic acid, octyl myristic acid, butoxy-ethyl stearic acid, anhydro solbitan monostearate, anhydro solbitan distearate, anhydro solbitan stearate, oleyl alcohol, and lauryl alcohol.

Further, there existed following surface-active agent: nonionic surface-active agent such as alkylene oxide family, glycerol family, glycidol family, and alkyl phenol-ethylene oxide adduct, cationic surface-active agent such as ring chain amine, ester amine, quaternary ammonium salt compound, hydantoin derivative, heterocyclic compound, and phosphonium compound or sulfonium compound, anionic surface-active agent including acidic group such as carboxylic acid, sulfonic acid, phosphoric acid, sulfuric ester group, and phosphoric ester group, amphoteric surface-active agent such as amino acid compound, amino sulfonic acid compound, sulfuric or phosphoric ester compound of amino alcohol, and alkylbetaine type.

Actual products of above-mentioned surface-active agent are as follows: manufactured by Nippon Oil & Fat Corp. such as NAA-102, NAA-415, NAA-312, NAA-160, NAA-180, NAA-174, NAA-175, NAA-222, NAA-34, NAA-35, NAA-171, NAA-122, NAA-142, NAA-160, NAA-173K, NAA-42, NAA-44, fatty acid cured by castor oil, Cation SA, Cation MA, Cation AB, Cation BB, Naimeen L-201, Naimeen L-202, Naimeen S-202, Nonion E-208, Nonion P-208, Nonion S-207, Nonion K-204, Nonion NS-202, Nonion NS-210, Nonion HS-206, Nonion L-2, Nonion S-2, Nonion S-4, Nonion 0-2, Nonion LP-20R, Nonion PP-40R, Nonion SP-60R, Nonion OP-80R, Nonion OP-85R, Nonion ST-221, Nonion OT-221, Monogly MB, Nonion DS-60, Anon BF, Anon LG, butylstearate, butyllaurate, and erucic acid, manufactured by Takemoto Oil & Fat Co., Ltd. such as FAL-205 and FAL-123, manufactured by New Japan Chemical Co. such as Enjerub LO, Enjerub IPM, and Sonsosizer E4030, manufactured by Shin-Etsu Chemical Co. such as TA-3, KF-96, KF-96L, KF-96H, KF-410, KF-420, KF-965, KF-54, KF-56, KF-907, KF-851, X-22-819, X-22-822, KF-905, KF-700, KF-393, KF-857, KF-860, KF-865, X-22-980, KF-101, KF-102, KF-103, X-22-3710, X-22-3715, KF-910, and KF-3935, manufactured by Lion-Armor such as Armide P, Armide C, and Armoslip CP, manufactured by Lion Yushi such as Duomin TDO, manufactured by Nisshin Oil Mills, Ltd. such as BA-41G, manufactured by Sanyo Chemical Industries Ltd. such as Prophan 2012E, New pole PE61, Ionet MS-400, Ionet MO-200, Ionet DL-200, Ionet DS-300, Ionet DS-1000, and Ionet DO-200.

A solvent utilized for mixing and dispersing magnetic powder and resin and additives in the present invention is as follows: ketonic compound such as acetone, methyl ethyl ketone, methyl isobutyl ketone, di-isobutyl ketone, cyclohexane, isophorone, and tetrahydrofuran, alcoholic compound such as methanol, ethanol, propanol, butanol, isobutyl alcohol, isopropyl alcohol, and methyl cyclohexanol, ester compound such as methyl acetate, butyl acetate, isobutyl acetate, isopropyl acetate, lactate ethyl, glycol acetate, glycol ether compound such as glycol dimethyl ether, glycol monomethyl ether, and dioxane, aromatic hydrocarbon compound such as benzene, toluene, xylene, cresol, and chlorobenzene, chlorinated hydrocarbon such as methylene chloride, ethylene chloride, carbon tetrachloride, chloroform, ethylene chlorohydrin, and dichlorobenzene, and N, N-dimethyl formamide, and hexane. They can be used alone or as a mixture of several solvents.

When mixing and dispersing these materials, using a continuous kneader or a pressure kneader such as an extruder at a state in which solid concentration of paint is extremely high as many as 70 to 80% is extremely effective in dispersion. However, the solid concentration of paint is required to be reduced so as for the paint to be able to paint. After letdown of concentration, the paint in lower solid concentration is further dispersed by such equipment as a sand mill. Therefore, several steps are necessary for a process of mixing and dispersion and the process becomes complicated. Accordingly, a dispersion system, which is composed of a combination of a horizontal sand mill and a dispersion tank with utilizing a ceramic bead as a dispersing medium, is considered as the present invention.

A magnetic powder in accordance with the first embodiment of the present invention is produced by following steps. Aqueous solution of iron chloride (FeCl₂) is poured into an agitation tank and aqueous solution of sodium hydroxide is poured therein with agitating the aqueous solution of iron chloride gently. Further, suspension of the aqueous solution of iron chloride and sodium hydroxide is kept in a temperature range of 40 to 50° C. and oxidized with blowing air therein. The air is stopped blowing when a length of major axis of a particle becomes a desired length by sampling the suspension. The suspension is filtered and powder of γ-FeOOH is obtained after rinsing and drying sufficiently. The powder is reacted for three hours at a temperature of 300° C. in an atmosphere of hydrogen gas, and then reacted for 30 minutes in an atmosphere of air of 200° C. and finally Fe₃O₄ (magnetite) is obtained. The magnetite powder is poured into a tank in which aqueous solution of cobalt sulfate is agitated gently and aqueous solution of sodium hydroxide is added therein. The solution of cobalt sulfate and sodium sulfate mixed with magnetite powder is filtered, rinsed and dried and finally a magnetite powder adhered with cobalt is obtained. The magnetite powder with cobalt is poured into a tank in which mixture of aqueous solution of aluminum sulfate and water glass is agitated gently, and then the mixture and the magnetite powder with cobalt are reacted by adding aqueous solution of sodium sulfate therein. Total solution is filtered, rinsed and dried, and then powder is obtained.

Five kilograms of the powder are poured into the New Speed Kneader (manufactured by Okada Seiko Co., Ltd.) composed of an agitation chamber having a capacity of 100 litters. One hundred grams of methyl triethoxy silane (A-1100, manufactured by Nippon Unicar Co.), which are mixed and diluted with 300 ml of ethanol, are gradually added into the Kneader with agitating the powder. Further, 800 grams of carbon black (Raven 1000, manufactured by Columbia Carbon Japan Ltd.) having an average particle diameter of 24 nm are added and agitated for 30 minutes. Ethanol is volatilized by leaving the powder in an atmosphere of 100° C. for 30 minutes. The powder in which ethanol is volatilized is loaded in a classifier and classified.

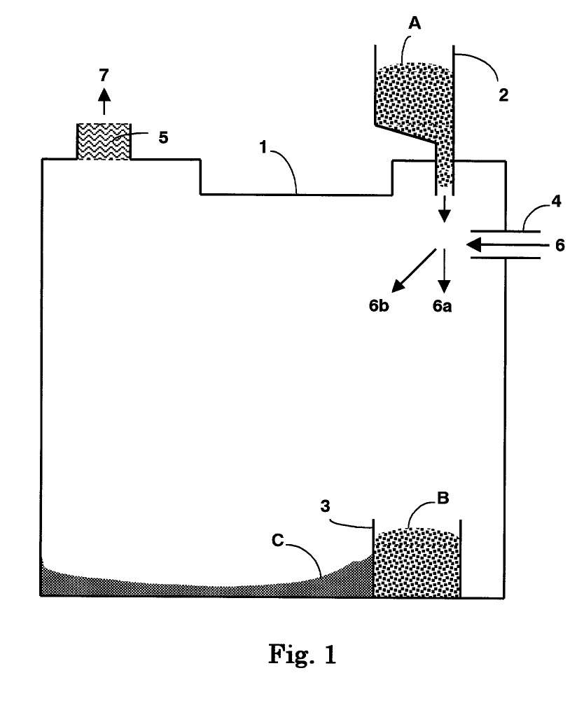

FIG. 1 is a cross sectional view of a classifier, which is utilized for manufacturing magnetic powder used for a magnetic recording medium according to the first and third embodiments of the present invention. In FIG. 1, the classifier is comprises a chamber 1, a powder feeder 2, a parting 3, an intake 4 for a side wind 6, and an air filter 5 for exhausting gas 7. As shown in FIG. 1, mixed powder “A,” which is produced as mentioned above, is loaded in a hopper of the powder feeder 2 and falls down on a bottom of the chamber 1 through the side wind 6. The mixed powder “A” is classified by the side wind 6 such as powder “B” and carbon “C”. The powder “B” is particles of extracting carbon “C”, which is not stuck on a surface of magnetic powder, and utilized for a magnetic tape. The side wind 6 is created by dry nitrogen gas and airflow of the dry nitrogen gas is adjusted so as for a falling course of carbon particle to be remarkably shifted. The mixed powder “A” falls into the chamber 1 through a throat of the powder feeder 2 and is blown by the side wind 6. A finer and lighter particle such as a carbon particle in the mixed powder “A” is remarkably affected by a force of the side wind 6 and a falling course of the carbon particle is shifted to a direction of 6b, and finally the carbon “C” accumulates on the bottom of the chamber 1. A magnetic powder stuck with a carbon particle in the mixed powder “A” is larger and heavier than a carbon particle itself, so that the magnetic powder is hardly affected by the side wind 6 and falls toward a direction of 6a. Accordingly, the powder “B” accumulates inside the parting 3 separating the carbon “C” on the bottom of the chamber 1. The side wind 6 is finally exhausted through the air filter 5 as the exhausting gas 7. These processes mentioned above are a typical function of a classifier.

A location of the parting 3 is adjusted so as to collect fine articles more and so as for the fine articles not to intermix with magnetic powder. By this experiment, 288 grams of carbon can be obtained as the fine articles out of 800 grams of the carbon black used. Accordingly, 512 grams of carbon black are stuck on the magnetic powder. The magnetic powder produced as mentioned above is acicular powder of which a major axis length is 0.15 μm, an acicular ratio is 9, a saturation magnetization is 72 emu/g, and a coercive force is 57.2 kA/m respectively. Such the magnetic power is considered as the magnetic powder “A”.

By utilizing the New Speed Kneader as an agitating device and using a magnetite powder in various magnetic characteristics and particle shapes and carbon black in various particle diameters, it is found from a feasible study of a stable magnetic recording medium that carbon black must be stuck uniformly on a surface of a magnetite powder. In order to stick carbon black on a surface of magnetite powder uniformly, it is important for a magnetite powder to be a primary particle by taking a massive magnetite powder apart into small pieces. It is rather easy for a magnetite powder in lower magnetization to be a primary particle. However, a magnetite powder in higher magnetization is hard to take apart into small pieces so as to be a primary particle. With respect to cohesion of a magnetite powder in higher magnetization, it is supposed that the cohesion is caused by an affection of magnetism. Accordingly, in a case of producing a video tape being required to use a magnetite powder in higher magnetization, most suitable operating conditions of an agitating device such as a shape of impeller, a number of rotation, and a pouring amount of magnetite powder are predetermined, and then a magnetite powder is poured into the agitating device and agitated. Finally, a coupler and carbon black are added after confirming that the magnetite powder is a primary particle.

In the manufacturing process of magnetic powder mentioned above, various kinds of magnetic powder “A” through “I” are obtained as shown in Table 1 by changing an additive amount of silane coupler diluted into methanol and carbon in the New Speed Kneader.

TABLE 1

| | Addition amount | | |
|---|---|---|---|
| | of methyl | Addition amount | Sticking |
| Magnetic | triethoxy silane | of carbon black | amount |
| powder | (weight part) | (weight part) | (weight part) |
| A | 1.00 | 16.0 | 10.2 |
| B | 0.30 | 3.1 | 1.0 |
| C | 0.50 | 7.0 | 5.1 |
| D | 2.00 | 35.0 | 19.8 |
| E | 0.20 | 2.0 | 0.8 |
| F | 0.05 | 2.0 | 0.7 |
| G | 0.00 | 0.0 | 0.0 |
| H | 3.00 | 41.0 | 21.1 |
| I | 4.00 | 40.0 | 22.0 |

Note:
1. Magnetic powder is 100 weight parts.
2. The magnetic powder “G” is not processed by the New Speed Kneader.

By using each magnetic powder shown in Table 1, magnetic paint is produced by compositions shown in Table 2.

TABLE 2

| | Weight | |
|---|---|---|
| Composition | part | Remarks |
| Magnetic powder | 100 | |
| Polyvinylchloride resin: MR110 (Zeon Corp.) | 9 | |
| Polyurethane resin: UR8300 (Toyobo Co., Ltd.) | 9 | Solid body |
| Chromium oxide: S-1 (Nippon Chemical) | 3 | |
| Alumina abrasive: E330 (Norton Corp.) | 2 | |
| Cyclohexanone | 50 | |
| Methyl ethyl ketone | 50 | |
| Toluene | 80 | |
| Myristic acid | 2 | |
| Palmitic acid | 2 | |
| Carbon black: Raven 1000 | X | |

The components shown in Table 2 are mixed and dispersed by a horizontal sand mill by using ceramic beads, and then 3 weight parts of Colonate HL (manufactured by Nippon Polyurethane Industry Co.) as an isocyanate resin are added and agitated. Finally, magnetic paint for coating is produced. A magnetic tape for the VHS format in one half inch wide is produced through processes such as coating the magnetic paint on a surface of polyethylene terephthalate (PET) film in 12 μm thick so as for a thickness of magnetic paint to be 4.2 μm after coated magnetic paint is dried, calendering and hardening the isocyanate resin by heating, and cutting. In the calendering process, a coefficient of kinetic friction on a surface of magnetic layer is adjusted by changing a temperature of a pressure roll and a calendering roll nip pressure. Samples of magnetic tapes produced as mentioned above are shown in following Table 3.

TABLE 3

| | Magnetic | Addition amount | Coefficient of |
|---|---|---|---|
| Magnetic tape | powder of | carbon black | kinetic friction |
| (Sample) | used | (X weight part) | (μk) |
| Embodiment 1 | A | 0 | 0.15 |
| Embodiment 2 | B | 0 | 0.10 |
| Embodiment 3 | B | 0 | 0.20 |
| Embodiment 4 | B | 0 | 0.40 |
| Embodiment 5 | C | 0 | 0.20 |
| Embodiment 6 | D | 0 | 0.10 |
| Embodiment 7 | D | 0 | 0.40 |
| Comp. Example 1 | A | 0 | 0.50 |
| Comp. Example 2 | B | 0 | 0.55 |
| Comp. Example 3 | C | 0 | 0.55 |
| Comp. Example 4 | E | 0 | 0.20 |
| Comp. Example 5 | F | 0 | 0.31 |
| Comp. Example 6 | G | 0 | 0.35 |
| Comp. Example 7 | H | 0 | 0.27 |
| Comp. Example 8 | I | 0 | 0.20 |
| Comp. Example 9 | G | 5 | 0.12 |

Characteristics such as a light transmission ratio, a coefficient of kinetic friction and an electrical resistance on a surface of magnetic layer, an electromagnetic conversion characteristic, and head stain while running are measured for each sample of magnetic tape. A light transmission ratio is measured by using a tape optical tester VT-1M (manufactured by Victor Company of Japan, Ltd.)

A coefficient of kinetic friction on a surface of magnetic layer of each magnetic tape (sample) is obtained by measuring a tape tension in a take-up side while running a magnetic tape at a speed of 3.3 cm/s, wherein the magnetic tape is wound around a stainless steel pin in a diameter of 8 mm by 180 degrees with facing a magnetic layer of the tape toward the stainless steel pin and 50 grams of tension is applied to the magnetic tape. Further, surface roughness (Ra) of the stainless steel pin is 50 nm.

An electrical resistance on a surface of magnetic layer is measured such that an electrical current flowing through two electrodes allocated in a distance of one half inch between them with applying a voltage of 500 V across the electrodes is measured, wherein the electrodes are allocated so as to face toward a magnetic layer of a magnetic tape in one half inch wide. An electromagnetic conversion characteristic is measured with an output and a C/N of a reproduced signal as shown in a following Table 4 by recording a sinusoidal wave signal of 4 MHz on a magnetic tape, wherein the magnetic tape is recorded by using a remodeled VHS deck such that a signal can be directly supplied to a head.

A head stain while running is observed such that a sample tape is rolled up in a VHS tape cassette by 246 meters and the sample tape rolled up in the cassette is recorded all over whole tape length in a surrounding of a temperature of 20° C. and a humidity of 10% by a VHS video deck, model No. HR-VK5 manufactured by Victor Company of Japan, Ltd., and further the sample tape recorded for approximately 2 hours is reproduced and rewound repeatedly 100 times and finally a head drum is removed from the video deck, and then a sliding surface of a head is observed by a microscope. In a case that a stain is not recognized on the sliding surface of the head, a judgement is marked by “◯” in Table 4. In a case that a stain reaches in a head gap, a judgement is marked by “×”.

TABLE 4

| | Light | Electrical | Out- | | |
|---|---|---|---|---|---|
| Magnetic tape | transmission | resistance | put | C/N | Head |
| (Sample) | ratio (%) | Ω/cm² | dB | dB | stain |
| Embodiment 1 | 0.4 | 4 × 10⁸ | 0.0 | 0.0 | ◯ |
| Embodiment 2 | 1.1 | 1 × 10⁹ | 0.3 | 0.4 | ◯ |
| Embodiment 3 | 1.1 | 1 × 10⁹ | 0.3 | 0.5 | ◯ |
| Embodiment 4 | 1.1 | 1 × 10⁹ | 0.4 | 0.5 | ◯ |
| Embodiment 5 | 0.8 | 6 × 10⁸ | 0.2 | 0.2 | ◯ |
| Embodiment 6 | 0.1 | 1 × 10⁸ | −0.3 | −0.4 | ◯ |
| Embodiment 7 | 0.1 | 1 × 10⁸ | −0.2 | −0.3 | ◯ |
| Comp. Example 1 | 0.4 | 4 × 10⁸ | 0.0 | −0.2 | X |
| Comp. Example 2 | 1.1 | 1 × 10⁹ | 0.3 | 0.3 | X |
| Comp. Example 3 | 0.8 | 6 × 10⁸ | 0.2 | 0.1 | X |
| Comp. Example 4 | 1.3 | 1 × 10¹⁰ | 0.5 | 0.6 | ◯ |
| Comp. Example 5 | 1.4 | 1 × 10¹⁰ | 0.6 | 0.6 | ◯ |
| Comp. Example 6 | 2.0 | 5 × 10¹² | 0.8 | 0.9 | ◯ |
| Comp. Example 7 | 0.1 | 8 × 10⁷ | −2.1 | −2.7 | ◯ |
| Comp. Example 8 | 0.1 | 8 × 10⁷ | −2.0 | −2.5 | ◯ |
| Comp. Example 9 | 0.8 | 1 × 10⁸ | −2.8 | −3.0 | ◯ |

Note:
1. Output and C/N are based on those of Embodiment 1 as a reference (0 dB).
2. Head stain is judged by observing a head by a microscope after running a tape.

From the measurement results mentioned above, following items are cleared.

The head stain is remarkable for a comparative examples 1 through 3 of which coefficient of kinetic friction on the surface of respective magnetic layer exceeds 0.4. All of a comparative example 4 utilizing a magnetic powder “E” of which a sticking amount of carbon black is less than 1.0% (weight part), a comparative example 5 utilizing a magnetic powder “F”, and a comparative example 6 utilizing a magnetic powder “G” being not stuck with carbon black are higher in the light transmission ratio and the electrical resistance on a surface of magnetic layer than other embodiments and examples. The light transmission ratio of these comparative examples exceeds 1.2%, which does not satisfy the VHS standard and causes a problem of detecting a tape end. Further, static electricity is remarkably generated due to high electrical resistance on the surface of magnetic layer and it is recognized that a noise caused by discharging static electricity interferes with a reproduced signal. A comparative example 7 utilizing a magnetic powder “H” of which a sticking amount of carbon black exceeds 20% (weight part) and a comparative example 8 utilizing a magnetic powder “I” is poor in the electromagnetic conversion characteristic. Furthermore, a comparative example 9 of which a magnetic powder is not stuck with carbon black and magnetic paint is added with carbon black is further inferior to the comparative examples 7 and 8 in the electromagnetic conversion characteristic.

On the other hand, embodiments 1 through 7 are superior to the comparative examples 1 through 9 in a light transmission ratio, an electrical resistance on a surface of magnetic layer, and an electromagnetic conversion characteristic, and generate no static electricity while running in a deck and exhibit the light transmission ratio satisfying the VHS standard. Further, by regulating a coefficient of kinetic friction on a surface of magnetic layer in a range of 0.1 to 0.4, no head stain is existed after reproducing whole length of a 2-hour tape 100 times repeatedly.

Accordingly, an amount of carbon black particles being stuck on a surface of a magnetite particle is desired to be within a range of 1 to 20 weight %. In a case of less than 1 weight %, either a light transmission ratio or an electrical resistance on a surface of magnetic layer does not satisfy a specification, so that a function as a magnetic recording medium is deteriorated. It results in adding carbon black separately. An essential object of increasing dispersion can not be realized by adding carbon black separately. In such a way as the characteristics are not improved by carbon black of less than 1 weight %, it is considered such that particles of carbon black sticking on a surface of magnetic powder are too few to exhibit its effect.

Further, in a case that an amount of carbon black particles is more than 20 weigh %, an excellent light transmission ratio and electrical resistance can be obtained. However, other electrical characteristics such as an output and C/N are extremely deteriorated. If carbon black particles are too much, some carbon black particles may drop out from a magnetic powder. These dropped out carbon black particles cause a same action as that of a simple substance of carbon black itself. Accordingly, dispersion of carbon black is deteriorated.

Furthermore, according to the first embodiment, it is apparent that a magnetic tape can be characterized by an amount of carbon black sticking on a magnetic powder. Accordingly, a magnetic recording medium having a desired characteristic can be realized by adjusting a sticking amount of carbon black such that realizing a magnetic recording medium being excellent in an electromagnetic conversion characteristic is targeted, and such that by increasing a light shielding ability and by thinning a magnetic layer realizes a long play type tape.

[Second Embodiment]

(Embodiments 8 to 14 and Comparative examples 10 to 14)

Prior to a detailed description of a second embodiment of the present invention, an outline of the present invention is explained first. First of all, a major point of the present invention is similar to that of the first embodiment. Therefore, the same description as that of the first embodiment is abbreviated.

Magnetite powder in an acicular shape is utilized for a core material of magnetic powder composing a magnetic layer of the present invention. A magnetite powder of Fe₃O₄ is superior to Fe₂O₃ in magnetization and is suitable for realizing an excellent magnetic characteristic. In a case that the magnetite powder is utilized for a magnetic recording medium as a core material, a metallic additive such as Co, Ni, Mn, Sn, or Cr is adhered on a surface of the magnetite powder for a purpose of improving a magnetic characteristic and corrosion resistance. Further, in order to prevent a magnetic powder from sintering during a manufacturing process of the magnetic powder, it is commonly performed that another metallic additive such as Al or Si is adhered on the surface of the core material or the magnetite powder. An experiment is performed by using special magnetic powder, which is furthermore stuck with particles of powdered carbon black layering over a metallic additive such as Co, Ni, Mn, Sn, Cr, Al, or Si adhered on the surface of the core material or the magnetite powder. According to the experiment, the particles of powdered carbon black layered over the metallic additive adhered on the surface of the magnetite powder is not affected by such the metallic additive, so that an effect of sticking particles of powdered carbon black on a magnetite powder, which is made most suitable for a magnetic characteristic and corrosion resistance and sintering respectively, is confirmed.

Further, a sticking amount of carbon black, which sticks on a surface of magnetite powder, is desired to be within a range of 3 to 15 weight %.

In a case that a sticking amount of carbon black is less than 3 weight %, a light transmission ratio and an electrical resistance on a surface of magnetic layer of a magnetic recording medium for the VHS format including the S-VHS format and the D-VHS format is relatively high and the magnetic recording medium is lacking in running stability. It results in adding carbon black separately. Accordingly, an essential object of increasing dispersion can not be realized by adding carbon black separately. In such a way as the characteristics are not improved by carbon black of less than 3 weight %, it is considered such that particles of carbon black sticking on a surface of magnetic powder are too few to exhibit its effect.

On the other hand, in a case that a sticking amount of carbon black exceeds 15 weight %, a light transmission ratio and an electrical resistance on a surface of magnetic layer of a magnetic recording medium for the VHS format including the S-VHS format and the D-VHS format is relatively in an excellent value. However, the other electric characteristics and glossiness of a tape surface is deteriorated. This is caused by too much carbon black particles. Some carbon black particles may drop out from a magnetite powder while producing magnetic paint. These dropped out carbon black particles cause a same action as that of a simple substance of carbon black itself. Accordingly, dispersion of carbon black is deteriorated.

Further, a value of specific surface area measured by the Brunauer-Emmett-Teller (BET) equation, hereinafter called a BET value, of the magnetic powder is desired to be within a range of 25 to 45 m²/g. In a case of a BET value is less than 20 m²/g, a particle size of magnetic powder is too large to comply with a high density recording. On the other hand, in a case that the BET value exceeds 45 m²/g, a particle size of magnetic powder is too small to disperse by means of a current technology. Accordingly, a characteristic can not be improved. The BET equation is one method of measuring a surface area of powder or a fine particle by sticking nitrogen on a surface of the fine particle.

Furthermore, an absorbing amount of myristic acid of the magnetic powder is within a range of 8 to 25 mg/g. Such the sticking amount remarkably affects improvement in dispersion of magnetic paint and a characteristic of a magnetic recording medium thereafter. It is hard to reduce an absorbing amount of myristic acid to less than 8 mg/g due to an initial characteristic of magnetite and carbon black powders. In a case of more than 25 mg/g, dispersion is deteriorated. This is caused by that a carbon black powder does not uniformly stick on a surface of a magnetite powder.

According to the present invention, a particle diameter of carbon black is desired to be within a range of 10 to 40 nm. In a case of less than 10 nm, such carbon black is hard to handle. In a case of more than 40 nm, it is hard to stick carbon black on a surface of magnetite powder in a layer structure.

Product names of carbon black are the same as those of the first embodiment.

Generally, a carbon black particle is fine and absorbs much oil, so that carbon black is hard to disperse when added into magnetic paint. By observing a process of sticking carbon black on a surface of magnetic powder, an agitating condition is optimized so as for carbon black added to stick completely on a surface of magnetic powder. In other words, an impeller shape and size of an agitating device and time duration of agitation is optimized. Observing a magnetite powder stuck with carbon black, which is produced by the above-mentioned process, under a microscope recognizes that no carbon black particle exists alone. Further, it is observed as if a particle of magnetic powder became thicker by being stuck with carbon black.

Utilizing a silane coupler is effective for sticking carbon black on a magnetite powder. The silane coupler utilized for sticking carbon black on a magnetite powder is the same as that of mentioned in the first embodiment.

A process of sticking carbon black powder on a magnetic powder is as follows: a magnetic powder is poured into a agitating device first, a mixture of alcohol and silane coupler is poured while agitating the magnetic powder, carbon black is poured thereafter and agitated so as to stick the carbon black on the magnetite powder.

A resin constituting a magnetic layer according to the present invention in conjunction with the magnetic powder mentioned above functions as a binder. Such resin as a binder is thermoplastic resin, thermosetting resin, reactive resin, and their mixture. These resins are, for example, polymer or copolymer such as vinyl chloride, nitrocellulose, vinyl acetate, vinyl alcohol, maleic acid, acrylic acid, acrylate, vinylidene chloride, acrylonitrile, methacrylic acid, methacrylate, styrene, butadiene, ethylene, vinylbutyral, vinyl-acetal, and vinyl ether, and resins such as polyurethane resin, . phenol resin, epoxy resin, polyurethane curable resin, urea resin, melamine resin, alkyd resin, acrylic family reactive resin, formaldehyde resin, silicon resin, epoxy polyamide resin, and a mixture of polyester resin and isocyanate prepolymer.

With respect to a resin constituting the magnetic layer of the present invention, the above-mentioned resins can be used alone or as a combination of several resins. However, more preferable resin is a combination of one of vinyl chloride resin, vinyl chloride vinyl acetate resin, vinyl chloride vinyl alcohol acetate resin, and copolymer of vinyl chloride vinyl acetate maleic anhydride, and both of polyurethane resin and polyisocyanate.

Actual product name of the resin mentioned above is the same as that of the first embodiment.

With respect to a nonmagnetic powder contained in the magnetic layer of the present invention, there provided alumina, silicon carbide, chromium oxide, cerium oxide, α-iron oxide, corundum, silicon nitride, titanium carbide, titanium oxide, silicon dioxide, and boron nitride. A particle size of these powders is desired to be within a range of 0.01 to 4 μm. It is possible to use them alone or as a combination of various materials and particle sizes. Further, carbon black can be added as much as dispersion is not deteriorated by the carbon black. Actual product names of these nonmagnetic powders are the same as those of the first embodiment although they are explained as an abrasive.

With respect to additives constituting the magnetic layer of the present invention, the same additives as those of the first embodiment are utilized.

A solvent utilized for mixing and dispersing magnetic powder and resin and additives, which constitute the magnetic layer of the present invention, is the same as that of the first embodiment.

With respect to a raw material of a nonmagnetic substrate coated with component materials mentioned above, any materials utilized commonly for a magnetic recording medium can be used. A typical material is, for example, a polyester family such as polyethylene terephthalate (PET), polyethylene-2, and 6-naphtalate, and aramid and polycarbonate. A form of a nonmagnetic substrate is usually a film or a tape. Its thickness is desired to be less than 20 μm. Further, in order to improve adhesiveness between a nonmagnetic substrate and a magnetic layer, a surface treatment such as corona treatment can be applied on a surface of nonmagnetic substrate before coating magnetic paint thereon.

When mixing and dispersing these materials, using a continuous kneader or a pressure kneader such as an extruder at a state in which solid concentration of paint is extremely high as many as 70 to 80% is extremely effective in dispersion. However, the solid concentration of paint is required to be reduced so as for the paint to be able to paint. After letdown of concentration, the paint in lower solid concentration is further dispersed by such equipment as a sand mill. Therefore, several steps are necessary for a process of mixing and dispersion and the process becomes complicated. Accordingly, a dispersion system, which is composed of a combination of a horizontal sand mill and a dispersion tank with utilizing a ceramic bead as a dispersing medium, is considered as the present invention.

Details of the second embodiment are depicted next.

A magnetic powder in accordance with the second embodiment of the present invention is produced such that a surface of magnetite (Fe₃O₄) powder is stuck with a carbon black particle, wherein a sticking amount of carbon black particles is within a range of 3 to 15 weight %.

Such magnetite powders, which are produced as mentioned above, are shown in Table 5.

TABLE 5

| | BET | Amount of | Amount of | | |
|---|---|---|---|---|---|
| Magnetite | value | cobalt | SiO₂ | Hc | σs |
| powder | (m²/g) | (weight %) | (weight %) | (kA/m) | (emu/g) |
| a | 36.7 | 3.4 | 1.8 | 76.2 | 77.5 |
| b | 26.1 | 3.4 | 1.6 | 75.8 | 77.9 |
| c | 43.9 | 3.4 | 1.9 | 76.5 | 77.2 |
| d | 21.1 | 3.8 | 1.5 | 75.5 | 78.1 |
| e | 49.5 | 3.2 | 2.1 | 77.0 | 77.0 |

In order to stick a carbon black powder on a magnetite powder and produce magnetite powders “a” through “e” shown in Table 5, any one of following processes 1 through 4 is utilized.

[Process 1]:

Pour 5 kg of magnetite powder into the New Speed Kneader and agitate. Pour silane coupler mixed with ethanol into the Kneader after agitating the magnetite powder for 20 minutes and agitate them for 10 minutes further. Add carbon black to a mixture of magnetite powder, silane coupler, and ethanol with taking 10 minutes. Agitate them all for 30 minutes more after the carbon black is added, and then the process 1 is completed.

[Process 2]:

Pour 5 kg of magnetite powder into the New Speed Kneader and agitate. Pour silane coupler mixed with ethanol into the Kneader after agitating the magnetite powder for 20 minutes and agitate them for 10 minutes further. Add carbon black to a mixture of magnetite powder, silane coupler, and ethanol with taking 10 minutes. Agitate them all for 30 minutes more after the carbon black is added, and then take out a powder of mixture from the Kneader. Pour the powder of mixture into a mulling chamber of a pressure kneader and agitate the powder for 10 minutes, and then the process 2 is completed.

[Process 3]:

Pour 5 kg of magnetite powder into the New Speed Kneader and agitate. Pour silane coupler mixed with ethanol into the Kneader after agitating the magnetite powder for 20 minutes and agitate them for 10 minutes further. Add carbon black to a mixture of magnetite powder, silane coupler, and ethanol with taking 10 minutes. Agitate them all for 30 minutes more after the carbon black is added, and then take out a powder of mixture form the Kneader. Pour the powder of mixture into a mulling chamber of a pressure kneader and agitate the powder of mixture for 30 minutes, and then the process 2 is completed.

[Process 4]:

Pour 5 kg of magnetite powder into the New Speed Kneader and agitate. Pour silane coupler mixed with ethanol into the Kneader after agitating the magnetite powder for 20 minutes and agitate them for 10 minutes further. Add carbon black to a mixture of magnetite powder, silane coupler, and ethanol with taking 10 minutes. Agitate them all for 30 minutes more after the carbon black is added, and then take out a powder of mixture form the Kneader. Pour the powder of mixture into a mulling chamber of a pressure kneader and agitate the powder of mixture for 60 minutes, and then the process 2 is completed.

In addition thereto, followings are common to the processes 1 through 4.

1) The New Speed Kneader is manufactured by Okada Seiko Co., Ltd. A capacity of an agitating chamber is 100 liters.

An agitating impeller is optimized for being suitable for agitating powder. In other words, the agitating impeller is designed so as for powder to fly up.

2) Solution of silane coupler is gushed out through a narrow nozzle with being pressurized and added into the Kneader so as to be mixed with powder uniformly.

3) A pressure kneader is utilized. However, a cover of mulling chamber is not pressurized and closed so as for powder filled inside the chamber not to scatter. A filling ratio of static bulk of powder to a mulling chamber is set to approximately 50%. Further, a clearance between a mulling paddle and an inner wall of the mulling chamber is extended to 10 mm so as for an acicular magnetic powder not to be damaged by strong grinding stress.

By using the magnetite powders “a” through “e” shown in Table 5, powders of mixture shown in Table 6 are obtained by means of the processes 1 through 4 mentioned above. Methyl ethoxy silane, which is A-1100 of Nippon Unicar Co., is utilized as a silane coupler. The methyl ethoxy silane is mixed with ethanol at a ratio of 50:50 and the mixture of methyl ethoxy silane and ethanol is added so as to produce a magnetic powder. Added carbon black is Raven 1000 manufactured by Columbia Carbon Japan Ltd. Accordingly, by using these additives, samples of magnetic powders shown in Table 6 are obtained.

TABLE 6

| | | Sticking | Additive | Process | | Absorbing |
|---|---|---|---|---|---|---|
| | Magne- | amount | amount | of | | amount of |
| Magnetic | tite | of | of | sticking | BET | myristic |
| powder | Powder | carbon | coupler | carbon | value | acid |
| (Sample) | used | (wt %) | (wt %) | black | (m²/g) | (mg/g) |
| 1 | a | 6.0 | 2.0 | 4 | 36.1 | 8 |
| 2 | a | 6.0 | 2.0 | 3 | 36.9 | 15 |
| 3 | a | 6.0 | 2.0 | 2 | 37.1 | 25 |
| 4 | a | 3.0 | 1.5 | 3 | 36.9 | 17 |
| 5 | a | 15.0 | 3.0 | 3 | 37.2 | 10 |
| 6 | b | 6.0 | 2.0 | 3 | 27.0 | 12 |
| 7 | c | 6.0 | 2.0 | 3 | 44.1 | 19 |
| 8 | a | 6.0 | 2.0 | 1 | 37.6 | 34 |
| 9 | a | 1.0 | 1.0 | 3 | 36.0 | 22 |
| 10 | a | 20.0 | 3.5 | 3 | 36.8 | 24 |
| 11 | d | 6.0 | 2.0 | 3 | 21.4 | 10 |
| 12 | e | 6.0 | 2.0 | 3 | 49.8 | 17 |

Note:
1. A sticking amount (wt %) of carbon is a weight ratio of carbon black to magnetite powder.
2. An additive amount (wt %) of coupler is a weight ratio of coupler to magnetite powder. The coupler is mixed with ethanol in a ratio of 50:50, so that an additive amount of solution of the coupler and ethanol is twice the weight of the coupler.

An absorbing amount of myristic acid is measured by sampling the powder after carbon black is added during the agitating process mentioned above. The absorbing amount of myristic acid is measured by following steps (1) through (3):

(1) Pour 5 grams of magnetic powder into an Erlenmeyer's flask with a sealing plug. Add 50 ml of solution of myristic acid into the flask and plug. Vibrate the flask by an ultrasonic vibrator for 24 hours.

(2) Keep the flask stable for 24 hours and collect supernatant liquid.

(3) Measure a concentration difference between the solution of myristic acid originally poured into the flask and myristic acid contained in the supernatant liquid by a gas chromatography, and then obtain an absorbing amount by the concentration difference. In this embodiment, methyl ethyl ketone is utilized as a solvent. Adding methyl ethyl ketone to 20 grams of myristic acid makes 1 liter of solution.

An absorbing amount of myristic acid by powder tends to decrease with a progress of sticking carbon black. According to an observation of sampled powder by an electron microscope, carbon black existing in a particle shape can not be seen with a progress of sticking carbon black. A particle of magnetic powder becomes thicker and it seems like such that carbon black sticks on a surface of a particle of magnetic powder in strata. However, a condition of the powder observed by the electron microscope does not perfectly link with an absorbing amount of myristic acid, there existed some gaps.

In order to realize an excellent magnetic recording medium, a trial magnetic tape utilized for the VHS, S-VHS, and D-VHS formats is produced. In a case of producing a magnetic recording medium of a coated type utilized for such the formats, a magnetic powder of an acicular shape is used. It is effective for improving an electromagnetic conversion characteristic of a magnetic recording medium that such an acicular shaped magnetic powder is magnetically oriented so as to increase a magnetic characteristic of the magnetic recording medium in a longitudinal direction of the magnetic recording medium. Further, a length of an acicular shaped magnetic powder must be shorter than a wavelength of a signal to be recorded on the medium. In consideration of dispersion of magnetic powder, it is most suitable for use that a major axis length of a particle of magnetic powder is within a range of 0.07 to 0.2 μm.

With respect to an amount of saturation magnetization and coercive force as magnetic characteristics of a magnetic powder, the larger the amount of saturation magnetization is, the more excellent characteristic a reproduced output exhibits. However, saturation magnetization within a range of 68 to 81 emu/g is practical in consideration of corrosion resistance. A coercive force within a range of 54 to 90 kA/m is practical although a coercive force is usually adjusted in accordance with a format to be used.

Leaving the magnetic powder shown in Table 6 in an atmosphere of 90° C. for 60 minutes and vaporizing ethanol produces a magnetic paint containing compositions shown in a following Table 7.

TABLE 7

| | Weight | |
|---|---|---|
| Composition | part | Remarks |
| Magnetic powder (5 kg) | 100 | |
| Polyvinylchloride resin: MR110 (Zeon Corp.) | 9 | |
| Polyurethane resin: UR8300 (Toyobo Co.) | 9 | Solid body |
| Chromium oxide: S-1 (Nippon Chemical) | 3 | |
| Alumina abrasive: E330 (Norton Co.) | 2 | |
| Cyclohexanone | 50 | |
| Methyl ethyl ketone | 50 | |
| Toluene | 80 | |

All compositions shown in Table 7 are dispersed for 3 hours by a horizontal sand mill containing a ceramic bead therein as a dispersion medium. The dispersed components is poured into an agitating device and kept at a temperature of less than 25° C. With agitating the dispersed components, one weight part of myristic acid, 2 weight parts of palmitic acid, and 3 weight parts of Colonate HL (manufactured by Nippon Polyurethane Industry Co.) as an isocyanate resin are added into the agitating device, and then a magnetic paint for coating is obtained.

A magnetic tape for the VHS system in one half inch wide is produced through processes such as coating the magnetic paint on a surface of polyethylene terephthalate (PET) film in 12 μm thick so as for a thickness of magnetic paint to be 4.2 μm after coated magnetic paint is dried, calendering and hardening a resin by heating, and cutting. Samples of magnetic tapes produced as mentioned above are shown in following Table 8.

TABLE 8

| Sample of magnetic tape | Magnetic powder used |
|---|---|
| Embodiment 8 | 1 |
| Embodiment 9 | 2 |
| Embodiment 10 | 3 |
| Embodiment 11 | 4 |
| Embodiment 12 | 5 |
| Embodiment 13 | 6 |
| Embodiment 14 | 7 |
| Comparative example 10 | 8 |
| Comparative example 11 | 9 |
| Comparative example 12 | 10 |
| Comparative example 13 | 11 |
| Comparative example 14 | 12 |

A degree of glossiness on a coated surface of a magnetic tape is measured with cutting out a piece of sample sheet from the magnetic tape coated with a magnetic paint before calendering. Characteristics such as a light transmission ratio, an electrical resistance on a surface of a magnetic layer, and an electromagnetic conversion characteristic are measured for each sample of magnetic tape shown in Table 8. A light transmission ratio is measured by using the tape optical tester VT-1M (manufactured by Victor Company of Japan, Ltd.) An electrical resistance on a surface of magnetic layer is measured such that an electrical current flowing through two electrodes allocated in a distance of one half inch between them with applying a voltage of 500 V across the electrodes is measured, wherein the electrodes are allocated so as to face toward a magnetic layer of a magnetic tape in one half inch wide. An electromagnetic conversion characteristic is measured with an output and a C/N of a reproduced signal by recording a sinusoidal wave signal of 5 MHz on a magnetic tape, wherein the magnetic tape is recorded by using a remodeled VHS deck such that a signal can be directly supplied to a magnetic head of the deck.

Measured results of a light transmission ratio, an electrical resistance on a surface of a magnetic layer, an output and C/N of a reproduced signal, and a degree of glossiness are shown in a following Table 9.

TABLE 9

| | Light | Electrical | Out- | | Glossi- |
|---|---|---|---|---|---|
| Magnetic tape | transmission | resistance | put | C/N | ness |
| (Sample) | ratio (%) | (Ω/cm²) | (dB) | (dB) | (%) |
| Embodiment 8 | 0.6 | 7 × 10⁸ | 0.0 | 0.0 | 115 |
| Embodiment 9 | 0.6 | 7 × 10⁸ | −0.2 | −0.2 | 102 |
| Embodiment 10 | 0.6 | 7 × 10⁸ | −0.3 | −0.4 | 101 |
| Embodiment 11 | 1.0 | 1 × 10⁹ | 0.2 | 0.3 | 103 |
| Embodiment 12 | 0.2 | 3 × 10⁸ | −0.5 | −0.6 | 98 |
| Embodiment 13 | 0.6 | 7 × 10⁸ | −0.5 | −0.5 | 101 |
| Embodiment 14 | 0.6 | 7 × 10⁸ | −0.3 | −0.3 | 102 |
| Comp. Example 10 | 0.6 | 7 × 10⁸ | −1.6 | −1.7 | 81 |
| Comp. Example 11 | 1.6 | 1 × 10¹⁰ | −0.1 | −0.2 | 102 |
| Comp. Example 12 | 0.1 | 1 × 10⁸ | −1.7 | −2.0 | 90 |
| Comp. Example 13 | 0.5 | 7 × 10⁸ | −0.9 | −1.1 | 101 |
| Comp. Example 14 | 0.8 | 7 × 10⁸ | −1.1 | −1.2 | 92 |

Note:
Output and C/N are based on those of Embodiment 8 as a reference (0 dB).

It is found that only an absorbing amount of myristic acid reflects on a dispersing condition of magnetic paint and an electromagnetic conversion characteristic of a magnetic recording medium. In a case of a comparative example 10 utilizing a magnetic powder 8 of which-the absorbing amount of myristic acid is as large as 34 mg/g, both output and C/N of electromagnetic conversion characteristic are in a low level. Further, a degree of glossiness on a surface of magnetic layer is also low. Judging from the low degree of glossiness, it is supposed that the magnetic powder 8 is defective in dispersion. In a case of a comparative example 11 utilizing a magnetic powder 9 of which a sticking amount of carbon is as small as 1.0%, both light transmission ratio and electrical resistance on a surface of magnetic layer are in a high level.

In a case of a comparative example 12 utilizing a magnetic powder 10 of which a sticking amount of carbon is as large as 20%, both output and C/N of electromagnetic conversion characteristic are in a low level. Further, a degree of glossiness on a surface of magnetic layer is relatively low. It is caused by excessive sticking amount of carbon. In a case of a comparative example 13 utilizing a magnetic powder 11 of which BET value is as low as 21.4, both output and C/N of electromagnetic conversion characteristic are in a low level. However, a degree of glossiness is not so low. Accordingly, it is obvious that the electromagnetic conversion characteristic is low due to a large particle of the magnetic powder 11 although a dispersion condition of the magnetic powder 11 is excellent. In a case of a comparative example 14 utilizing a magnetic powder 12 of which a BET value is as high as 49.8, both output and C/N of electromagnetic conversion characteristic are in a low level. Further, a degree of glossiness on a surface of magnetic layer is also low. Judging from the value of the degree of glossiness, it is understood that the magnetic powder 12 is defective in dispersion. On the other hand, embodiments 8 through 14 exhibit excellent values in a light transmission ratio, an electrical resistance on a surface of magnetic layer, and an output and C/N of an electromagnetic conversion characteristic. Further, a degree of glossiness is also high enough.

According to the present invention, by using a magnetic powder having a proper BET value and an absorbing amount of myristic acid although the magnetic powder is produced such that a surface of magnetite powder is stuck with a predetermined amount, that is, 3 to 15 weight % of carbon black powder, a magnetic recording medium, which is excellent in an electric characteristics by an effect of synergy, can be obtained.

[Third Embodiment]

(Embodiments 15 to 2 and Comparative examples 15 to 22)

Prior to a detailed description of a third embodiment of the present invention, an outline of the present invention is explained first. First of all, a major point of the present invention is similar to that of the first embodiment. Therefore, the same description as that of the first embodiment is abbreviated.

The present invention can provide a magnetic recording medium, which is excellent in strength of a coated film of a recording layer, durability, an output, surface roughness, and a microscopic dropout.

The microscopic dropout is a general name for a dropout corresponding to a digital recording. In a case of the S-VHS and VHS formats, an output fall of proportions of −20 dB deep and 15 Its wide is usually a value, which is counted as a dropout. With respect to a digital recording in a near future, particularly, with respect to the D-VHS format, a small level of output change such as proportions of −6 dB deep and 0.5 μs wide is counted as a dropout. Essentially, such a dropout shall be controlled by an error rate. However, a dropout is specified by the D-VHS specification, so that such a dropout is described as a microscopic dropout in the present invention so as to distinguish a dropout of a digital recording from that of a current analog recording.

A magnetite powder in an acicular shape is utilized for a core material of a magnetic powder. A magnetite powder of Fe₃O₄ is superior to Fe₂O₃ in magnetization and is suitable for realizing an excellent magnetic characteristic. In a case that the magnetite powder is utilized for a magnetic recording medium as a core material, a metallic additive such as Co, Ni, Mn, Sn, or Cr is adhered on a surface of the magnetite powder for a purpose of improving a magnetic characteristic and corrosion resistance. Further, in order to prevent a magnetic powder from sintering during a manufacturing process of the magnetic powder, it is commonly performed that another metallic additive such as Al or Si is adhered on the surface of the core material or the magnetite powder. An experiment is performed by using special magnetic powder, which is furthermore stuck with particles of powdered carbon black layering over a metallic additive such as Co, Ni, Mn, Sn, Cr, Al, or Si adhered on the surface of the core material or the magnetite powder. According to the experiment, the particles of powdered carbon black layered over the metallic additive adhered on the surface of the magnetite powder is not affected by such the metallic additive, so that an effect of sticking particles of powdered carbon black on a magnetite powder, which is made most suitable for a magnetic characteristic and corrosion resistance and sintering respectively, is confirmed.

A ratio of sticking amount of carbon black in proportion to a magnetite powder must be within a range of 1 to 20 weight %. In a case of less than 1 weight %, carbon black does not show its sticking effect. Accordingly, an electrical resistance on a surface of magnetic layer increases and a dropout level is remarkably deteriorated. On the other hand, in a case that a sticking amount of carbon black exceeds 20 weight %, dispersion of a coated film is deteriorated due to excessive carbon black, which does not stick on a magnetite powder, and surface roughness is also deteriorated. Accordingly, defects such as head stain increase.

With respect to a particle size of magnetite powder, a magnetic recording medium is utilized for various applications such as a magnetic card, a ticket for traffic facilities, a magnetic tape, and a magnetic disk, so that the particle size can not be limited to a specific one. However, in a case of manufacturing a video tape, which is utilized for a high density recording such as the VHS format mentioned above, such a magnetite powder as an acicular shape of which a length of major axis is within a range of 0.05 to 1.0 μm preferably a range of 0.07 to 0.2 μm is suitable for use. With respect to an aciculate ratio of acicular powder, an aciculate ratio being suitable for use is 3 to 25 preferably 5 to 15 in consideration of destruction of a magnetic powder during mixture and dispersion, magnetic orientation after coating magnetic paint on a substrate, and a magnetic characteristic of a magnetic recording medium thereafter. With respect to an amount of saturation magnetization and coercive force as magnetic characteristics of a magnetic powder, the larger the amount of saturation magnetization is, the more excellent characteristic a reproduced output exhibits. However, a saturation magnetization within a range of 68 to 81 emu/g of is practical in consideration of corrosion resistance. A coercive force within a range of 54 to 90 kA/m is practical although a coercive force is usually adjusted in accordance with a format to be used.

A coupling agent is effective in sticking a carbon black particle on a magnetite powder. A coupling agent used herein is the same as those shown in the first embodiment.

With respect to a diameter of particle of carbon black stuck on a surface of magnetite powder, a particle diameter of carbon black is preferably to be within a range of 10 to 40 nm in comparison with a desirable particle length of a major axis of magnetic powder, which is within a range of 0.07 to 0.2 μm, although a relative dimension of a carbon black particle to a particle of magnetic powder is considered so as to be stuck on a surface of magnetic powder.

Actual product names of carbon black are the same as those shown in the first embodiment.

With respect to a nonmagnetic powder contained in the magnetic layer of the present invention, there provided alumina, silicon carbide, chromium oxide, cerium oxide, or iron oxide, corundum, silicon nitride, titanium carbide, titanium oxide, silicon dioxide, and boron nitride. A particle size of these powder is desired to be a range of 0.01 to 4 /μm. However, it is also possible to use them alone or as a combination of various materials and particle sizes. Further, carbon black can be added as much as dispersion is not deteriorated by the carbon black. Actual product names of these nonmagnetic powders are the same as those shown in the second embodiment.

With respect to additives constituting the magnetic layer of the present invention, the same additives as those of the first embodiment are utilized and actual product names of additives are the same as those shown in the first embodiment.

A solvent utilized for mixing and dispersing magnetic powder and resin and additives in the present invention is the same as those shown in the first embodiment.

With respect to a binder composing a magnetic layer in conjunction with a magnetic powder, a polyurethane resin including metal sulfonate group and tertiary amine is utilized. The metal sulfonate group is a polar group introduced into polyurethane resin and is such as, for example, sodium sulfite, sodium bisulfite, potassium bisulfite, sodium sulfanilic acid, and sodium sulfamic acid. The tertiary amine is a polar group introduced into a polyurethane resin and is such as, for example, fatty acid amine, aromatic amine alkanolamine, and alkoxy alkylamine. Further, there provided dimethyl amine, diethyl amine, di-isopropyl amine, di-isobuthyl amine, metal ethanol amine, dioctyl amine, N-methylanilin, N-methyl butylamine, N-methyl phenyl amine, 2-methoxy ethylamine, di-2-methoxy ethylamine.

A thermoplastic resin, thermosetting resin, reactive resin, and their mixture can be used as a binder other than polyurethane resin. As for the thermoplastic resin, there provided resins such as vinyl chloride-vinyl acetate copolymer, vinyl chloride-vinyl acetate-vinyl alcohol copolymer, vinyl chloride-vinyl acetate-maleic acid copolymer, vinyl chloride-vinylidene chloride copolymer, polyamide resin, and polyvinyl butyral. As for the thermosetting and reactive resins, such resins as phenol resin, epoxy resin, acrylic family reactive resin, epoxy-polyamide resin, nitrocellulose-melamine resin are available. A combination of polyurethane resin and vinyl chloride-vinyl acetate copolymer is well balanced in strength and softness and is most suitable for the present invention. Actual product names of binders are as follows: manufactured by Union Carbide such as VAGH, VAGF, and UCM569, manufactured by Zeon Corp. such as MR100, MR105, MR110, and MR113, and manufactured by Nissin Chemical Industrial Co. such as MPR-TA and MPR-TOA.

With respect to polyurethane resin utilized for a binder in the present invention, it can be obtained by a reaction of poly-hydroxy compound with poly-isocyanate. The metal sulfonate group and tertiary amine can be introduced by the commonly known technology and they are not limited to a specific material. An introduction amount of metal sulfonate group is desirable to be within a range of 0.01 to 0.3 mmol/g. In a case of less than 0.01 mmol/g, it is not recognized that the metal sulfonate group shows an effect of dispersing a ferromagnetic powder, that is, a magnetite powder stuck with a carbon black powder. On the other hand, in a case that the introduction amount of metal sulfonate group exceeds 0.3 mmol/g, a ferromagnetic powder is re-cohesive, so that dispersion stability of the ferromagnetic powder tends to be deteriorated.

With respect to an introducing amount of tertiary amine, it is desirable to be within a range of 0.05 to 0.7 mmol/g. In a case of less than 0.05 mmol/g, dispersion of ferromagnetic powder is insufficient, so that surface roughness of a magnetic layer tends to be deteriorated. On the other hand, in a case that the introducing amount of tertiary amine exceeds 0.7 mmol/g, a coated film becomes fragile, so that a predetermined magnetic characteristic can not be obtained.

Further, a numerical mean molecular weight of polyurethane resin is desirable to be within a region of 8000 to 50000. In a case of less than 8000, strength of a coated film as a magnetic recording layer is insufficient, so that possible dropout may increase due to a dropping out of coated film components. On the other hand, in a case that the numerical mean molecular weight of polyurethane resin exceeds 50000, viscosity of magnetic paint increases because solubility of polyurethane resin with solvent decreases. Accordingly, decreased solubility causes a problem in a manufacturing process of magnetic paint.

With respect to a raw material of a nonmagnetic substrate coated with component materials mentioned above, any materials utilized commonly for a magnetic recording medium can be used. A typical material is, for example, a polyester family such as polyethylene terephthalate (PET), polyethylene-2, and 6-naphtalate, and aramid and polycarbonate. A form of a nonmagnetic substrate is usually a film or a tape. Its thickness is desired to be less than 20 μm. Further, in order to improve adhesiveness between a nonmagnetic substrate and a magnetic layer, a surface treatment such as corona treatment can be applied on a surface of nonmagnetic substrate before coating magnetic paint thereon.

A magnetic recording medium in accordance with the third embodiment of the present invention is produced such that the aforementioned magnetic powder and binder components are dispersed in conjunction with solvent by a dispersion device commonly known. When mixing and dispersing these materials, using a continuous kneader or a pressure kneader such as an extruder at a state in which solid concentration of paint is extremely high as many as 70 to 80% is extremely effective in dispersion. However, the solid concentration of paint is required to be reduced so as for the paint to be able to paint. After letdown of concentration, the paint in lower solid concentration is further dispersed by such equipment as a sand mill. Therefore, several 4 steps are necessary for a process of mixing and dispersion and the process becomes complicated. Accordingly, a dispersion system, which is composed of a combination of a horizontal sand mill and a dispersion tank with utilizing a ceramic bead as a dispersing medium, is considered as the present invention. Further, various additives are added thereafter. Mixture of solution, that is, a magnetic paint is coated on a surface of a substrate through a filtering process. The coated substrate is cut into a predetermined shape after the magnetic paint is dried and processed through a surface treatment. Any kinds of materials commonly known can be utilized for a substrate to be coated with the magnetic paint.

A magnetic powder in accordance with the third embodiment of the present invention is produced by the same steps as explained in the first embodiment. The mixed powder “A”, which is produced by the New Speed Kneader, is classified by the classifier shown in FIG. 1 and a magnetic powder in accordance with the third embodiment is produced.

In the manufacturing process of a magnetic powder mentioned above, various kinds of magnetic powder “AA” through “FF” are obtained as shown in Table 10 by changing an additive amount of silane coupler diluted into methanol and carbon in the New Speed Kneader.

TABLE 10

| | Addition amount of | | |
|---|---|---|---|
| | methyl triethoxy- | Addition amount | Sticking amount |
| Magnetic | silane | of carbon black | of carbon black |
| powder | (weight part) | (weight part) | (weight part) |
| AA | 1.0 | 16.0 | 10.2 |
| BB | 0.3 | 3.1 | 1.0 |
| CC | 2.0 | 35.0 | 19.8 |
| DD | 0.2 | 2.0 | 0.8 |
| EE | 4.0 | 40.0 | 22.0 |
| FF | 0.0 | 0.0 | 0.0 |

Note:
1. Magnetic powder is 100 weight parts.
2. The magnetic powder “FF” is not processed by the New Speed Kneader.

By using each magnetic powder shown in Table 10, magnetic paint is produced by compositions shown in Table 11.

In the third embodiment, a magnetic recording tape for high density recording utilized for the S-VHS and D-VHS formats is manufactured. By using respective polyurethane resins “R” through “Z” shown in Table 12, a magnetic paint is produced in accordance with the prescription shown in Table 11.

TABLE 11

| Composition | Weight part |
|---|---|
| Magnetic powder (shown in Table 10) | 100 |
| Polyvinylchloride resin: MR110 (Zeon Corp.) | 10 |
| Polyurethane resin (shown in Table 12 below) | 10 |
| Alumina abrasive: E330 (Norton Co.) | 8 |
| Palmitic acid | 2 |
| Phosphoric ester | 1 |
| Methyl ethyl ketone | 120 |
| Toluene | 120 |

TABLE 12

| | Introduction amount of | Introduction amount of |
|---|---|---|
| Polyurethane | metal sulfonate group | tertiary amine |
| resin | (mmol/g) | (mmol/g) |
| R | 0 | 0.2 |
| S | 0.01 | 0.05 |
| T | 0.3 | 0.2 |
| U | 0.01 | 0.5 |
| V | 0.1 | 0.7 |
| W | 0.1 | 1.0 |
| X | 0.3 | 0 |
| Y | 0.5 | 0.2 |
| Z | 0.005 | 0.7 |

The above-mentioned compositions are dispersed for 8 hours in the sand mill and further mixed with 20 weight parts of tertiary isocyanate, Colonate L manufactured by Nippon Polyurethane Industry Co., and one weight part of isoamyle stearate by dispersion agitation. The mixture is adjusted by an organic solvent of mixture of methyl ethyl ketone and toluene for a predetermined magnetic paint thereafter. A magnetic tape for the VHS system in one half inch wide is produced through processes such as coating the magnetic paint on a surface of polyethylene terephthalate (PET) film in 12 μm thick, a magnetic orientation, a specular surface treatment, hardening by heat, and cutting. Accordingly, sample tapes shown in Table 13 are produced in accordance with the above-mentioned processes. However, in a case of a comparative example 17, an electrical resistance and a light shielding ability is not comply with the VHS standard, so that the comparative example 17 is produced by adding 5 weight parts of carbon black into the magnetic paint therein.

By using a VHS video deck, which is reconstructed such that a tape transporting speed is adjusted to 5.5 mm/s, a head stain caused by these sample tapes is confirmed after running a sample tape for 100 passes in an atmosphere of 40° C. and 90% of humidity.

Further, with respect to a coated film strength, a sample tape recorded with 5 MHz of a sinusoidal wave signal is fast fowarded and rewound repeatedly 1000 times in an atmosphere of −10° C., and then an expansion of the tape is measured by a shifting amount of a track pattern and it is compared with each sample tape as the coated film strength. Furthermore, 9.5 MHz of reproduced output and a C/N is measured by the above-mentioned video deck. With respect to a dropout, a gray scale signal is recorded on a sample tape and reproduced, and an output of the reproduced signal is measured by the dropout counter model VH01CZ, manufactured by Shibasoku Co. As for a measuring level of a dropout, a number of dropouts per minute is counted at a level of −16 dB/15 μs and another level of −6 dB/0.5 μs as a level of microscopic dropout. With respect to a surface roughness, it is measured by the non-contacting type tree dimensional surface roughness meter manufactured by Zygo Co. and an average surface roughness (SRa) is extracted. All measurement results are shown in Tables 13-1 and 13-2.

TABLE 13
1

| | Magnetic | Urethane | 1 | 2 |
|---|---|---|---|---|
| Magentic tape | powder | resin | Head | Track shift |
| (Sample) | used | used | stain | μm |
| Embodiment 15 | AA | S | ∘ | −33 |
| Embodiment 16 | AA | T | ∘ | −20 |
| Embodiment 17 | AA | U | ∘ | −24 |
| Embodiment 18 | AA | V | ∘ | −15 |
| Embodiment 19 | BB | S | ∘ | −25 |
| Embodiment 20 | CC | V | ∘ | −35 |
| Comp. Example 15 | DD | S | Δ | −30 |
| Comp. Example 16 | EE | V | x | −42 |
| Comp. Example 17 | FF | V | Δ | −62 |
| Comp. Example 18 | AA | W | x | −83 |
| Comp. Example 19 | AA | X | Δ | −70 |
| Comp. Example 20 | AA | Y | x | −58 |
| Comp. Example 21 | CC | R | x | −55 |
| Comp. Example 22 | CC | Z | x | −62 |

2

| | 3 | 4 | 5 | | 6 |
|---|---|---|---|---|---|
| Magnetic tape | Output | C/N | Dropout | | SRa |
| (Sample) | dB | dB | −16dB/15 μs | −6dB/0.5 μs | nm |
| Embodiment 15 | 0.9 | 1.2 | 5 | 23 | 3.2 |
| Embodiment 16 | 1.2 | 1.0 | 8 | 21 | 4.0 |
| Embodiment 17 | 1.0 | 1.3 | 16 | 35 | 3.7 |
| Embodiment 18 | 1.5 | 1.5 | 4 | 15 | 3.3 |
| Embodiment 19 | 1.4 | 1.5 | 10 | 30 | 4.5 |
| Embodiment 20 | 1.2 | 0.9 | 15 | 40 | 5.0 |
| Comp. Example 15 | 0.8 | 0.5 | 52 | 200 | 5.8 |
| Comp. Example 16 | 0.5 | −0.3 | 28 | 125 | 7.0 |
| Comp. Example 17 | 1.1 | 0.3 | 23 | 60 | 6.6 |
| Comp. Example 18 | −0.2 | −0.1 | 20 | 103 | 5.5 |
| Comp. Example 19 | 0.3 | −0.5 | 25 | 92 | 6.8 |
| Comp. Example 20 | 0.0 | −0.1 | 48 | 121 | 6.4 |
| Comp. Example 21 | −0.5 | −0.4 | 32 | 155 | 7.1 |
| Comp. Example 22 | 0.3 | −0.2 | 26 | 85 | 6.0 |

In Table 13-1, a judging standard of head stain is as follows:

“◯” ; No stain sticks on a head.

“Δ” ; Some stain sticks on a head.

“×” ; Some stain is clogged in a head gap.

Embodiments 15 through 20 shown in Tables 13-1 and 13-2 are comply with a magnetic recording medium of the present invention and show excellent values in coated film strength of a magnetic layer, durability, an output, a C/N, and a dropout. A comparative example 17 is weak in coated film strength due to added carbon black powder to the contrary. Accordingly, durability and surface roughness of the comparative example 17 is deteriorated. In a case of comparative examples 15 utilizing a magnetic powder DD of which sticking amount of carbon black is 0.8 weight %, an electrical resistance of a magnetic layer is high and a dropout level is extremely deteriorated, wherein the sticking amount of 0.8 weight % is lower level than that of a magnetic recording medium of the present invention.

In a case of a comparative example 16 utilizing a magnetic powder EE of which a sticking amount of carbon black is 22.0 weight %, dispersiveness of a coated film is deteriorated and its surface roughness is also deteriorated. Accordingly, it causes a head stain, wherein the sticking amount of 22.0 weight % is higher level than that of a magnetic recording medium of the present invention. In a case of a comparative example 18 utilizing a polyurethane resin “W” of which an introduction amount of tertiary amine is higher than other polyurethane resins, a coated film is fragile and dispersion is deteriorated. Accordingly, coated film strength, an output, and a C/N is extremely deteriorated.

Further, in a case of a comparative example 19 utilizing a polyurethane resin “X” of which an introduction amount of tertiary amine is a lowest of all, dispersion and coated film strength is deteriorated because a functional group is not effective. Accordingly, surface roughness is deteriorated and it causes an inferior C/N. In a case of a comparative example 20 utilizing a polyurethane “Y” of which an introduction amount of metal sulfonate group is higher, re-concentration of magnetic paint easily occurs and dispersion is deteriorated and a dropout is also deteriorated. On the other hand, in a case of a comparative example 21, which is not introduced with metal sulfonate group, and a comparative example 22, which is introduced with a small amount of metal sulfonate group, their surface roughness is deteriorated by defective dispersion because dispersion effect by metal sulfonate group is extremely deteriorated. Further, reliability of them is lowered.

[Fourth Embodiment]

(Embodiments 21 to 27 and Comparative examples 23 to 27)

Prior to a detailed description of a fourth embodiment of the present invention, an outline of the present invention is explained first. First of all, a major point of the present invention is similar to that of the first embodiment. Therefore, the same description as that of the first embodiment is abbreviated.

A magnetite powder in an acicular shape is utilized for a core material of a magnetic powder constituting a magnetic layer of the present invention. A magnetite powder of Fe₃O₄ is superior to Fe₂O₃ in magnetization and is suitable for realizing an excellent magnetic characteristic. Further, a magnetite powder is also excellent in chemical stability because of an oxide in comparison with a metallic magnetic powder.

Further, a sticking amount of carbon black, which sticks on a surface of a magnetite powder, must be within a range of 3 to 15 weight %. In a case of less than 3 weight %, no effect is exhibited by a fewer carbon black and an electrical resistance on a surface of magnetic layer is relatively high and a dropout level is extremely deteriorated. In a case that the sticking amount of carbon black exceeds 15 weight %, dispersion of a coated film is deteriorated due to excessive carbon black, which does not stick on a magnetite powder, and surface roughness is also deteriorated. Accordingly, defects such as head stain increase.

In order to realize an excellent magnetic recording medium, a magnetic recording medium, which can be used for the VHS, S-VHS, and D-VHS formats, is produced as a trial so as to obtain excellent characteristics when the magnetic recording medium is applied to those formats.

In a case of producing a coated type magnetic recording medium utilized for such formats mentioned above, a magnetic powder of an acicular shape is used. It is effective for improving an electromagnetic conversion characteristic of a magnetic recording medium that such acicular shaped magnetic powder is magnetically oriented so as to increase a magnetic characteristic of the magnetic recording medium in a longitudinal direction of the medium. In consideration of dispersion of magnetic powder, it is most suitable for use that a major axis length of a particle of magnetic powder is within a range of 0.07 to 0.2 μm. Such a magnetite powder having a major axis length of 0.07 to 0.2 μm is used for a trial production of a magnetic recording medium and the medium is evaluated. According to the evaluation, a BET value of a magnetic powder, which exhibits an excellent electromagnetic conversion characteristic, is within a range of 25 to 45 m²/g. In a case that a BET value is less than 25 m²/g, a desirable value of magnetic characteristic can not be obtained. In a case that the BET value exceeds 45 m²/g, dispersiveness of a magnetic powder is extremely deteriorated and a desirable electromagnetic conversion characteristic can not be obtained.

With respect to a relation between an amount of saturation magnetization and coercive force as magnetic characteristics of a magnetic powder, the larger the amount of saturation magnetization is, the more excellent characteristic a reproduced output exhibits. However, a saturation magnetization within a range of 68 to 81 emu/g is practical in consideration of corrosion resistance. A coercive force within a range of 54 to 90 kA/m is practical although a coercive force is usually adjusted in accordance with a format to be used.

In order to improve tape characteristics such as dispersiveness of a magnetic powder, light shielding ability and an electrical resistance of magnetic layer, tape stiffness, and reliability by using such the magnetite powder mentioned above, a trial production is repeated by sticking a carbon black powder on a surface of magnetite powder. After several trail productions, a stable production can not be realized because a dispersion condition of a magnetic paint is unstable and causes an electromagnetic conversion characteristic of a magnetic recording medium to scatter, a head contact to lower, and head stain to increase.

Accordingly, to solve the problem mentioned above, another magnetic recording medium is examined with paying attention to a mechanical strength of a magnetic recording medium. Usually, a magnetic recording medium is composed of a substrate and a magnetic layer, in some cases, composed of a foundation layer therein. Recently, a magnetic recording medium is advanced to a longer period of time of recording capability, so that a total thickness of the magnetic recording medium is obliged to be thinner. The thinner thickness causes a mechanical strength to lower and contact of the magnetic recording medium with a video head to deteriorate. A spacing loss occurs due to the deteriorated head contact and causes an output to lower and to be changeable.

With paying attention to compositions of magnetic paint in a magnetic layer, particularly, dispersiveness of magnetic paint, it is realized that a magnetic recording medium can be prevented from lowering mechanical strength by examining a use of the aforementioned magnetite powder stuck with a carbon black powder and a pH of the carbon black powder. In a case that a carbon black powder of which a pH exceeds 4 is used, dispersion of magnetic paint is deteriorated and a mechanical strength of magnetic tape produced is weaken.

This phenomenon is supposed such that an adhesion of magnetite powder with a binder is changed after a carbon black powder having a higher pH more than 4 is stuck on the magnetite powder, and dispersiveness of a magnetic paint is deteriorated. However, further details are not apparent. In a case that a pH of a carbon black powder to be used is less than 4, the carbon black powder is congenial to a binder, particularly, polyurethane resin and characteristics such as dispersiveness, an electromagnetic conversion characteristic, coated film strength, and surface roughness are improved. However, it is hard to obtain such a carbon black powder of which a pH is less than 2.

A silane coupler is utilized for sticking powdered carbon black on a magnetite powder. Magnetic powders or magnetite powders are poured into an agitating device. While agitating the magnetite powders, a mixture of alcohol and silane coupler is poured into the agitating device and further carbon black powders are added and agitated so as to stick the carbon black on a magnetite powder. In these agitating processes, equipment such as a pressure kneader, which applies grinding stress to mixed ir powders, is utilized as well as agitating the mixed powders by an impeller such as the New Speed Kneader.

Accordingly, it is realized that a magnetite powder can be uniformly stuck with powdered carbon black even though a small amount of coupling agent is used. With respect to a sticking amount of powdered carbon black, it is desired to be within a range of 3 to 15 weight %. In a case that a sticking amount of powdered carbon black is less than 3 weight %, it generates problems to a light transmission ratio and an electrical resistance as well as deteriorating dispersion. On the other hand, in a case of more than 15 weight %, excessive carbon black powders set free and cause a problem such as head stain due to a deteriorated electromagnetic conversion characteristic and defective dispersion.

Accordingly, the present invention provides a use of a magnetite powder, which is stuck with powdered carbon black having a BET value of 25 to 45 m2/g, for a video tape utilized for the VHS, S-VHS, and D-VHS formats so as to exhibit an excellent electromagnetic conversion characteristic. With respect to a sticking amount of powdered carbon black is decided with considering a light shielding ability and an electrical resistance. A sticking amount of powdered carbon black necessary to fulfill the above-mentioned purpose is within a range of 3 to 15 weigh % per magnetite powder. To improve mechanical strength of a video tape, a pH of powdered carbon black is limited to less than 4. Accordingly, excellent electromagnetic conversion characteristic and head contact and high reliability can be realized.

With respect to a particle diameter of powdered carbon black to be stuck on a magnetite powder, the particle diameter is desired to be within a range of 10 to 40 nm. Actual product names of carbon black are the same as those of the first embodiment.

A coupling agent utilized for sticking powdered carbon black on a magnetite powder is the same as those mentioned in the first embodiment.

A resin constituting a magnetic layer according to the present invention in conjunction with the magnetite powder mentioned above functions as a binder. Such resin as a binder is thermoplastic resin, thermosetting resin, reactive resin, and their mixture. These resins are, for example, polymer or copolymer such as vinyl chloride, nitrocellulose, vinyl acetate, vinyl alcohol, maleic acid, acrylic acid, acrylate, vinylidene chloride, acrylonitrile, methacrylic acid, methacrylate, styrene, butadiene, ethylene, vinylbutyral, vinyl acetal, and vinyl ether, and resins such as polyurethane resin, phenol resin, epoxy resin, polyurethane curable resin, urea resin, melamine resin, alkyd resin, acrylic family reactive resin, formaldehyde resin, silicon resin, epoxy polyamide resin, and a mixture of polyester resin and isocyanate prepolymer.

The above-mentioned resins can be used alone or as a combination of several resins. However, more preferable resin is a combination of one of vinyl chloride resin, vinyl chloride vinyl acetate resin, vinyl chloride vinyl alcohol acetate resin, and copolymer of vinyl chloride vinyl acetate maleic anhydride, and both of polyurethane resin and polyisocyanate. Actual product names of resins as a binder are the same as those shown in the first embodiment.

With respect to a nonmagnetic powder utilized for an additive to a magnetic layer of the present invention, there provided alumina, silicon carbide, chromium oxide, cerium oxide, α-iron oxide, corundum, silicon nitride, titanium carbide, titanium oxide, silicon dioxide, and boron nitride. A particle size of these powder is desired to be a range of 0.01 to 4 μm. However, it is also possible to use them alone or as a combination of various materials and particle sizes. Further, carbon black can be added as much as dispersion is not deteriorated by the carbon black. Actual product names of nonmagnetic powders are the same as those shown in the second embodiment.

Additives having effects of lubrication, dispersion, and plasticity contained in a magnetic layer and their actual product names are the same as those explained in the first embodiment.

A solvent utilized for mixing and dispersing magnetic powder and resin and additives in the present invention is the same as those explained in the first embodiment.

When mixing and dispersing these magnetic powder, resin, and additives, using a continuous kneader or a pressure kneader such as an extruder at a state in which solid concentration of paint is extremely high as many as 70 to 80% is greatly effective in dispersion. However, the solid concentration of paint is required to be reduced so as for the paint to be able to paint. After letdown of concentration, the paint in lower solid concentration is further dispersed by such equipment as a sand mill. Therefore, several steps are necessary for a process of mixing and dispersion and the process becomes complicated. Accordingly, a dispersion system, which is composed of a combination of a horizontal sand mill and a dispersion tank with utilizing a ceramic bead as a dispersing medium, is considered as the present invention.

With respect to a raw material of a nonmagnetic substrate coated with component materials mentioned above, any materials utilized commonly for a magnetic recording medium can be used. A typical material is, for example, a polyester family such as polyethylene terephthalate (PET), polyethylene-2, and 6-naphtalate, and aramid and polycarbonate. A form of a nonmagnetic substrate is usually a film and a tape. Its thickness is desired to be less than 20 μm. Further, in order to improve adhesiveness between a nonmagnetic substrate and magnetic layer, a surface treatment such as corona treatment can be applied on a surface of nonmagnetic substrate before coating magnetic paint thereon.

A magnetic powder in accordance with a fourth embodiment of the present invention is explained next.

Table 14 shows magnetite powders “aa” through “ee”, which are utilized for the fourth embodiment of the present invention.

Table 15 shows powdered carbon black “J” through “M”.

In Table 14, “Amount of cobalt” represents an amount of cobalt stuck on a magnetite powder. “Amount of SiO₂” represents an amount of silicon dioxide coating a surface of a magnetic powder. “Hc” and “σs” represents coercive force and saturation magnetization respectively.

TABLE 14

| | BET | Amount of | Amount of | | |
|---|---|---|---|---|---|
| Magnetite | value | cobalt | SiO₂ | Hc | σS |
| powder | (m²/g) | (weight %) | (weight %) | (kA/m) | (emu/g) |
| aa | 36.7 | 3.4 | 1.8 | 76.2 | 77.5 |
| bb | 26.1 | 3.4 | 1.6 | 75.8 | 77.9 |
| cc | 43.9 | 3.4 | 1.9 | 76.5 | 77.2 |
| dd | 21.1 | 3.8 | 1.5 | 75.5 | 78.1 |
| ee | 49.5 | 3.2 | 2.1 | 77.0 | 77.0 |

TABLE 15

| Carbon | | | Particle diameter | BET |
|---|---|---|---|---|
| black | Product name | pH | (nm) | (m²/g) |
| J | Raven 1225B | 2.5 | 21 | 130 |
| K | Black Pearls-L | 2.5 | 24 | 138 |
| L | MA77 | 3.0 | 23 | 131 |
| M | MONARCH 1100 | 7.0 | 14 | 240 |

A process of sticking powdered carbon black shown in Table 14 on a magnetite powder shown in Table 15 is as follows: pour 5 kg of a magnetite powder into the New Speed Kneader and agitate. After agitating the magnetite powder for 20 minutes, pour silane coupler mixed with ethanol into the Kneader and agitate them for 10 minutes further. Add carbon black to a mixture of magnetite powder, silane coupler, and ethanol with taking 10 minutes. Agitate them all for 30 minutes more after the carbon black is added, and then take out powder of mixture form the Kneader. Pour the powder of mixture into a mulling chamber of a pressure kneader and agitate the powder for 30 minutes, and then the process is completed.

Followings are remarks for the process mentioned above.

1) The New Speed Kneader is manufactured by Okada Seiko Co., Ltd. A capacity of an agitating chamber is 100 liters. An agitating impeller is optimized for being suitable for agitating powder. In other words, the agitating impeller is designed so as for powder to fly up.

2) Solution of silane coupler is gushed out through a narrow nozzle with being pressurized and added into the Kneader so as to be mixed with powder uniformly.

3) A pressure kneader is utilized. However, a cover of mulling chamber is not pressurized and closed so as for powder filled inside the chamber not to scatter. A filling ratio of static bulk of powder to a mulling chamber is set to approximately 50%. Further, a clearance between a mulling paddle and an inner wall of the mulling chamber is extended to 10 mm so as for an acicular magnetic powder not to be damaged by strong grinding stress.

By using magnetite powders “aa” through “ee” shown in Table 14, one of carbon black powders “J” through “M” shown in Table 15 is stuck on one of the magnetite powders “aa” through “e” by the aforementioned process. Accordingly, magnetic powders 21 through 32 shown in Table 16 corresponding to sample numbers (embodiments 21 through 27 and comparative examples 32 through 27) are obtained.

TABLE 16

| | | | Sticking | | |
|---|---|---|---|---|---|
| | | | amount | | |
| | Magnetite | Carbon | of | BET | |
| Magnetic | powder | black | carbon | value | |
| powder | used | used | (wt %) | (m²/g) | Sample No. |
| 21 | aa | J | 6.0 | 36.9 | Embodiment 21 |
| 22 | aa | K | 6.0 | 37.0 | Embodiment 22 |
| 23 | aa | L | 3.0 | 37.2 | Embodiment 23 |
| 24 | aa | J | 3.0 | 37.1 | Embodiment 24 |
| 25 | aa | J | 15.0 | 37.5 | Embodiment 25 |
| 26 | bb | J | 6.0 | 26.2 | Embodiment 26 |
| 27 | cc | K | 6.0 | 43.5 | Embodiment 27 |
| 28 | aa | J | 1.0 | 35.9 | Comp. Example 23 |
| 29 | aa | J | 20.0 | 36.9 | Comp. Example 24 |
| 30 | aa | M | 6.0 | 37.3 | Comp. Example 25 |
| 31 | dd | J | 6.0 | 21.0 | Comp. Example 26 |
| 32 | ee | L | 6.0 | 49.8 | Comp. Example 27 |

Note: A sticking amount of carbon means a weight percent of carbon black per magnetite powder.

The silane coupler used herein is methyl triethoxy silane. The silane coupler is mixed with ethanol in a ratio of 50:5 and 2 weight % of the mixture are added to the magnetic powder shown in Table 16. The magnetic powder shown in Table 16 and the mixture of silane and ethanol is left in an atmosphere of 90° C. for 60 minutes and the ethanol is volatilized, and then a magnetic paint is produced in accordance with compositions shown in Table 17.

TABLE 17

| Composition | Weight part |
|---|---|
| Magnetic powder (as shown in Table 16) | 100 |
| Polyvinylchloride resin: MR110 (Zeon Corp.) | 8 |
| Polyurethane resin: UR8300 (Toyobo Co., Ltd.) | 8 |
| Chromium oxide: S-1 (Nippon Chemical Industry) | 2 |
| Alumina abrasive: E330 (Norton Co.) | 7 |
| Cyclohexanone | 30 |
| Methyl ethyl ketone | 80 |
| Toluene | 80 |

All compositions shown in Table 17 are dispersed for 5 hours by a horizontal sand mill containing a ceramic bead as a dispersion medium. The dispersed compositions is poured into an agitating device and kept at a temperature of less than 25° C. With agitating the dispersed components, one weight part of myristic acid and 20 weight parts of Colonate HL (manufactured by Nippon Polyurethane Industry Co.) as an isocyanate resin are added into the agitating device. A magnetic paint for coating is obtained after adjusting for a predetermined paint by a mixed organic solvent of methyl ethyl ketone and toluene.

A magnetic tape for the VHS format in one half inch wide is produced through processes such as coating the magnetic paint on a surface of polyethylene terephthalate (PET) film in 9.5 μm thick so as for a thickness of magnetic paint to be 2.2 μm after coated magnetic paint is dried, and magnetic orientation and specular treatment and hardening by heating and cutting. Samples of magnetic tapes produced as mentioned above are shown in Table 16.

A light transmission ratio and an electrical resistance on a surface of a trial video tape produced as mentioned above is measured. A light transmission ratio is measured by using the tape optical tester VT-1M (manufactured by Victor Company of Japan, Ltd.) An electrical resistance on a surface of magnetic layer is measured such that an electrical current flowing through two electrodes allocated in a distance of one half inch between them with applying a voltage of 500 V across the electrodes is measured, wherein the electrodes are allocated so as to face toward a magnetic layer of a magnetic tape in one half inch wide.

Further, an electromagnetic conversion characteristic is measured with a reproduction output and a C/N of a reproduced signal by recording a sinusoidal wave signal of 9 MHz on a magnetic tape, wherein the magnetic tape is recorded by using a remodeled VHS deck such that a signal can be directly supplied to a head. At the same time, in order to confirm a head contact, an output difference between an entry section and an exit section of an output signal is read out by using the oscilloscope Model 2445 (manufactured by Sony-Techtronics) and a degree of flatness of envelope is confirmed, wherein the output difference (V) is equal to dividing an output of entry section by an output of exit section. In other word, V=(output of entry section)÷(output of exit section).

Furthermore, by using a VHS video deck, which is reconstructed such that a tape transporting speed is adjusted to 5.5 mm/s, a head stain caused by these sample tapes is confirmed after running a sample tape for 100 passes in an atmosphere of 40° C. and 90% of humidity. A result of head stain examination is exhibited in Table 18 below.

TABLE 18

| | Light | | | | Head | |
|---|---|---|---|---|---|---|
| | trans- | | | | contact | |
| | mission | Electrical | Out- | | (Flat- | |
| Magnetic tape | ratio | resistance | put | C/N | ness) | Head |
| (Sample) | (%) | (Ω/cm²) | (dB) | (dB) | (%) | stain |
| Embodiment 21 | 0.6 | 7 × 10⁸ | 1.2 | 1.0 | 96.8 | ∘ |
| Embodiment 22 | 0.6 | 7 × 10⁸ | 0.9 | 1.2 | 97.2 | ∘ |
| Embodiment 23 | 0.6 | 8 × 10⁸ | 1.3 | 1.2 | 95.9 | ∘ |
| Embodiment 24 | 1.0 | 1 × 10⁸ | 1.5 | 1.5 | 98.1 | ∘ |
| Embodiment 25 | 0.2 | 2 × 10⁸ | 1.0 | 1.1 | 97.5 | ∘ |
| Embodiment 26 | 0.6 | 7 × 10⁸ | 0.8 | 0.9 | 96.5 | ∘ |
| Embodiment 27 | 0.6 | 8 × 10⁸ | 1.2 | 1.4 | 95.5 | ∘ |
| Comp. Example 23 | 1.6 | 3 × 10¹⁰ | 0.8 | 0.1 | 81.5 | Δ |
| Comp. Example 24 | 0.1 | 7 × 10⁷ | −0.1 | −0.4 | 72.4 | x |
| Comp. Example 25 | 0.6 | 7 × 10⁸ | −1.5 | −1.7 | 61.5 | x |
| Comp. Example 26 | 0.6 | 8 × 10⁸ | −1.2 | −0.8 | 86.5 | ∘ |
| Comp. Example 27 | 0.6 | 4 × 10⁸ | −1.0 | −0.7 | 79.2 | Δ |

Summary of measurements is shown in Table 18. In Table 18, 15 a judging standard of head stain is as follows:

“◯”; No stain exists on a head.

“Δ”; Some stain exist on a head.

“×”; Some stain are clogged in a head gap.

According to examinations of sample tapes shown in Table 18, followings are found. A comparative example 23 using the magnetic powder 28 of which sticking amount of powdered carbon black is as small as 1 weight % is high in a light transmission ratio and an electrical resistance on a surface of magnetic layer. In a case of a comparative example 24 using a magnetic powder 29 of which sticking amount of powdered carbon black is as many as 20 weigh %, an electromagnetic conversion characteristic is low and head stain is excessive. It is supposed to be caused by that dispersion is deteriorated due to excessive powdered carbon black adhered to a magnetite powder and saturation magnetization as a magnetic characteristic of a magnetic powder is deteriorated.

In a case of a comparative example 25 using a magnetic powder 30, which is composed of powdered carbon black having a pH 7.0, an output is remarkably decreased, further, tape stiffness and head stain is deteriorated. It is supposed to be caused by that a particle of powdered carbon black adhered to a magnetite powder affects dispersion. In a case of a comparative example 26 using a magnetic powder 31 of which a BET value is as small as 21.1 m²/g, head stain is reasonable but an electromagnetic conversion characteristic is low. It is caused by that a particle diameter of magnetic powder is too large to exhibit excellent characteristic when recording and reproducing in high density. In a case of a comparative example 27 using a magnetic powder 32 of which a BET value is as large as 49.5 m²/g, head stain exist and an electromagnetic conversion characteristic is low. It is supposed to be caused by that there existed a problem in dispersion because a magnetic powder is finer than necessary.

On the other hand, embodiments 21 through 27 are excellent in a light transmission ratio, an electrical resistance on a surface of magnetic layer, and an electromagnetic conversion characteristic. Further, head contact and head stain is also excellent. Accordingly, it is apparent that they are a superior magnetic recording medium.

According to an aspect of the present invention, there provided a magnetic recording medium, which is excellent in a light shielding ability, an electrical resistance on a surface of magnetic layer, and an electromagnetic conversion characteristic. Further, by regulating a coefficient of kinetic friction on a surface of magnetic layer to a range of 0.1 to 0.4, there provided a magnetic recording medium, which seldom causes a head stain.

According to another aspect of the present invention, there provided a magnetic recording medium, which can maintain an electrical resistance on a surface of magnetic layer low enough and a light shielding effect high enough and also can improve an electromagnetic conversion characteristic. Further, the magnetic recording medium is excellent in a tape running ability and low in a jitter of reproduced signal. Furthermore, the magnetic recording medium can reduce a manufacturing cost because a painting process of magnetic paint is simple.

According to a further aspect of the present invention, there provided a magnetic recording medium, which is excellent in coated film strength and durability by utilizing a polyurethane resin containing metal sulfonate group and tertiary amine as a binder, and exhibits a high reproduction output and an excellent surface roughness due to improved dispersion of magnetic powder by the binder, and which can comply with a high density digital recording such as the D-VHS format.

According to a furthermore aspect of the present invention, there provided a magnetic recording medium, which is excellent in tape stiffness and reliability by improving discursiveness of a magnetic paint during a process of mixing and dispersing a magnetic powder, a binder, and an additive, and by increasing a mechanical strength of a magnetic layer remarkably, particularly, by regulating a sticking amount of powdered carbon black adhered on a surface of a magnetite powder to a range of 3 to 15 weigh % per magnetite powder, and a pH of the powdered carbon black to less than 4, and a BET value of the magnetic powder to a range of 25 to 45 m2/g.

What is claimed is:

1. A magnetic recording medium of a coated type being formed by coating magnetic paint, which is mixed with and dispersed by a magnetic powder and a resin and an additive, on a substrate, said magnetic powder comprising magnetite (Fe₃O₄) powder of which a surface is stuck with powdered carbon black, wherein a sticking amount of said powdered carbon black is within a range of 1 to 20 weight % per said magnetite powder.

2. The magnetic recording medium in accordance with claim 1, wherein coefficient of friction on a surface of magnetic layer, which is formed by coating said magnetic paint on the substrate, is within a range of 0.1 to 0.4.

3. A magnetic recording medium of a coated type being formed by coating magnetic paint, which is mixed with and dispersed by a magnetic powder and a resin and an additive, on a substrate, said magnetic powder comprising magnetite (Fe₃O₄) powder of which a surface is stuck with powdered carbon black, wherein a sticking amount of said powdered carbon black is within a range of 3 to 15 weight % per said magnetite powder, and wherein a BET (Brunauer-Emmett-Teller) value of said magnetic powder is within a range of 25 to 45 m²/g, and wherein an absorbing amount of myristic acid of said magnetic powder is within a range of 8 to 25 mg/g.

4. A magnetic recording medium of a coated type being formed by coating magnetic paint, which is mixed with and dispersed by a magnetic powder and a binder and an additive, on a substrate, said magnetic powder comprising magnetite (Fe₃O₄) powder of which a surface is stuck with powdered carbon black, wherein a sticking amount of said powdered carbon black is within a range of 1 to 20 weight % per said magnetite powder, said binder comprising a polyurethane resin, which contains metal sulfonate group and tertiary amine.

5. A magnetic recording medium of a coated type being formed by coating magnetic paint, which is mixed with and dispersed by a magnetic powder and a binder and an additive, on a substrate, said magnetic powder comprising magnetite (Fe₃O₄) powder of which a surface is stuck with powdered carbon black, wherein a sticking amount of said powdered carbon black is within a range of 3 to 15 weight % per said magnetite powder and a pH of said powdered carbon black is less than 4, and wherein a BET value of said magnetic powder is within a range of 25 to 45 m²/g.
